(19) United States
(12) Patent Application Publication
(10) Pub. No.: US 2012/0249065 A1
(43) Pub. Date: Oct. 4, 2012

(54) MULTI-USE ENERGY MANAGEMENT AND CONVERSION SYSTEM INCLUDING ELECTRIC VEHICLE CHARGING

(76) Inventors: Michael Bissonette, Laguna Hills, CA (US); Omourtag A. Velev, La Crescenta, CA (US); Eric Aagaard, Los Angeles, CA (US)

(21) Appl. No.: 13/219,309

(22) Filed: Aug. 26, 2011

(30) Foreign Application Priority Data
Apr. 1, 2011 (US) PCT/US2011/030931

(51) Int. Cl. H02J 7/00

(52) U.S. Cl. 320/109

(57) ABSTRACT

An energy management method for controlling electric vehicle charging by managing plural local energy sources, to optimize charging speed and minimize energy cost.

### CROSS-REFERENCE TO RELATED APPLICATIONS

This application claims benefit under 35 USC §120 of International Application No. PCT/US2011/030931 filed Apr. 1, 2011 entitled MULTI-USE ENERGY MANAGEMENT AND CONVERSION SYSTEM INCLUDING ELECTRIC VEHICLE CHARGING, by Michael Bissonette, et al.

### TECHNICAL FIELD

The present invention in its several embodiments pertains to systems and methods of managing electric energy flow or power among different electric energy sources, for charging an electric vehicle and/or delivering power to one of the energy sources from one or more of the other energy sources.

### BACKGROUND

Electric vehicles offer a cleaner and potentially cheaper alternative to conventional fuel-powered vehicles. A typical electric vehicle (EV) has an electric motor coupled to the vehicle wheels and a rechargeable battery pack for powering the electric motor. The battery pack may be beneficially recharged at night (for example) when the electric vehicle is not in use and when electricity is generally more available and less expensive. For this purpose, the electric vehicle further includes an on-board charging system that can be plugged into a household utility outlet in the residential garage or car port where the electric vehicle is parked.

After a full day's use, it may be necessary to recharge the vehicle's battery pack for several or many hours, depending upon the charging capacity of the on-board charging system. This capacity is limited in order to reduce the size and weight of the on-board charging system, so as to reduce the weight and enhance the performance of the electric vehicle. Moreover, the charging rate is limited by the power rating of the household utility outlet. Such limitations have the undesirable effect of increasing the amount of time required to recharge the battery pack. Another problem is that the cost of recharging the battery pack is dictated by the rate schedule of the local electric utility supplier, and can be a function of the time of day, nighttime power being generally less expensive and daytime peak demand power being generally more expensive.

### SUMMARY OF THE INVENTION

A method is provided for managing electrical energy. In a first embodiment, the method includes coupling a direct current bus to plural energy sources and to a system port that is connectable to a charging port of an electric vehicle having a battery pack, the plural energy sources including a local energy storage device and a utility grid. The method further includes managing energy flow between the direct current bus and the plural energy sources by performing one mode of a set of modes. The set of modes includes a minimum time charging mode, a minimum cost charging mode, a green charging mode and a specified completion time charging mode. The method further includes providing on a graphical user interface a first menu representing a user-selectable choice among the set of modes and performing the mode designated by the user on the menu, and providing on a graphical user interface a second menu listing the plurality of electrical energy sources, and prompting the user to select one of the electrical energy sources listed on the menu as a recipient of power from the direct current bus, and configuring power flow among the plural energy sources and the direct current bus in accordance with a selection by the user of the recipient of power.

In accordance with a second embodiment, the method includes coupling a direct current bus to plural energy sources and to a system port that is connectable to a charging port of an electric vehicle having a battery pack, the plural energy sources including a local energy storage device and a utility grid. The method further includes managing energy flow between the direct current bus and the plural energy sources by performing one mode of a set of modes. The set of modes includes a minimum time charging mode, a minimum cost charging mode, a green charging mode and a specified completion time charging mode. The plural energy sources further include a local renewable energy source, and the one mode includes a return power to utility grid mode. The return power to utility grid mode includes enabling power flow to the direct current bus from the local renewable energy source. The method further includes determining whether a battery pack of an electric vehicle coupled to the system port requires charging. If the battery pack requires charging, then the method proceeds as follows: sensing a specified time by which the battery pack is to be fully charged; determining, from output power levels of the set of energy sources and from the amount of charge contained in the battery pack, an amount of time required to fully charge the battery pack in the minimum time charging mode; determining from the amount of time and from the specified time a spare time currently remaining before charging of the battery pack in the minimum time charging mode is required to commence. If the spare time is sufficient in accordance with a predetermined spare time criteria, power flow is enabled from the battery pack to the direct current bus.

If the spare time is not sufficient in accordance with the predetermined spare time criteria, no power is allowed to flow from the battery pack to the direct current bus. If the battery pack does not require charging, then power may be enabled to flow from the battery pack to the direct current bus.

In a further aspect, whenever power flows from the battery pack to the direct current bus, the method may further include periodically determining a new value of the spare time, and if the new value of the spare time is not sufficient in accordance with a predetermined spare time criteria, disabling power flow from the battery pack to the direct current bus.

In a yet further aspect, the method may further include determining whether a current energy rate of the utility grid meets a predetermined criteria, and enabling power flow from the direct current bus to the utility grid if the current energy rate meets the predetermined criteria, and otherwise postponing power flow from the direct current bus to the utility grid until the energy rate meets the predetermined criteria. The predetermined criteria may correspond to a predetermined threshold energy rate or to a range of energy rates prevalent during periods of peak demand.

In a still further aspect, the method may include enabling power flow from the direct current bus to the utility grid during successive time windows, the successive time windows selected so as to enhance or maximize income from power provided from the direct current bus to the utility grid.

In accordance with a third embodiment, the method includes coupling a direct current bus to plural energy sources and to a system port that is connectable to a charging port of an electric vehicle having a battery pack, the plural energy sources including a local energy storage device and a utility grid. The method further includes managing energy flow between the direct current bus and the plural energy sources by performing one mode of a set of modes. The set of modes includes a minimum time charging mode, a minimum cost charging mode, a green charging mode that enhances the fraction of energy usage from utility grid renewable sources of the utility grid, and a specified completion time charging mode. The one mode is the minimum cost charging mode, and the minimum cost charging mode includes charging the battery pack by flowing energy to the direct current bus from the local energy storage device, and first determining whether the utility grid is imposing an energy rate below a predetermined rate, and flowing energy from the utility grid to the direct current bus if the energy rate is below the predetermined rate. The first determining includes: first obtaining individual energy costs of the plural energy sources and the power contribution proportions of the plural energy sources; for individual combinations of the plural energy sources, computing a combined energy cost as an average of corresponding ones of the individual energy costs weighted by corresponding ones of the power contribution proportions; second obtaining a user-defined energy cost limit; and searching for a combination of the plural energy sources having a combined energy cost that is below the user-defined energy cost limit. The method further includes: charging the local energy storage device with energy from another or others of the plural energy sources prior to the first determining; during the charging of the local energy storage device, computing a first average of the individual energy costs weighted by the corresponding power contribution proportions of those of the plural energy sources providing energy to charge the local energy storage device, and storing the first average as a local energy storage device energy cost. The first obtaining includes defining the local energy storage device energy cost as the energy cost of the local energy storage device.

### BRIEF DESCRIPTION OF THE DRAWINGS

So that the manner in which the exemplary embodiments of the present invention can be understood in detail, a more particular description of the invention may be had by reference to the embodiments thereof which are illustrated in the appended drawings.

FIG. 1 is a diagram depicting an arrangement for charging the battery pack of an electric vehicle, including an energy management system interfacing with multiple energy sources, in accordance with one embodiment.

FIG. 2 is a diagram depicting the signal flow between the electric vehicle and the energy management system of FIG. 1.

FIG. 3 is a diagram depicting elements within the energy management system of FIG. 2.

FIG. 4 is a simplified block diagram depicting the simultaneous flow of power between a high voltage D.C. bus of the energy management system and the multiple energy sources, in accordance with one embodiment.

FIG. 5A is a block diagram depicting power flow in a mode in which local renewable energy sources charge a local energy storage device in absence of the electric vehicle being connected to the system.

FIG. 5B is a block diagram depicting power flow in a mode in which the electric vehicle is charged from available energy sources including the local energy storage device.

FIG. 5C is a block diagram depicting power flow in a mode adapted to provide backup power during a utility grid power outage.

FIG. 5D is a block diagram depicting power flow in a mode in which both the local energy storage device and the electric vehicle's battery-pack are charged simultaneously.

FIG. 5E is a block diagram depicting power flow in a mode in which power is returned to the utility grid.

FIG. 6 depicts the elements of a user interface of the energy management system of FIG. 1, and further depicts information flow from a multi-source utility grid supplier to the energy management system.

FIG. 7 depicts one example of a menu screen of the user interface of FIG. 6.

FIG. 8 is a flow diagram depicting one mode of operation of the energy management system of FIG. 2.

FIG. 9 is a flow diagram depicting how to carry out the operation in FIG. 8 of charging of the on-board battery pack of the electric vehicle.

FIG. 10 is a flow diagram depicting how to carry out the operation in FIG. 8 of charging of an energy storage device.

FIGS. 11A and 11B are respective flow diagrams depicting how the energy management system decides to flow electric power back to a smart utility grid, in accordance with respective embodiment.

FIGS. 12A and 12B depict a method of operation of the energy management system of FIG. 3 with interactive communication and control by the user, in accordance with an embodiment.

FIG. 13 depicts how one or more of the rechargeable sources can be selected to be the recipient of power in the method of FIGS. 12A and 12B.

FIG. 14 depicts a mode of the method of FIG. 12 in which charging is performed in minimum time.

FIGS. 15A, 15B and 15C depict embodiments of a mode of the method of FIGS. 12A and 12B in which charging is performed at minimum cost.

FIGS. 16A, 16B, 16C and 16D depict embodiments of a mode of the method of FIGS. 12A and 12B in which charging is performed using a maximum fraction of power derived from environmentally-friendly (green) energy sources.

FIGS. 17A and 17B depict embodiments of a mode of the method of FIGS. 12A and 12B in which charging is performed within a specified time.

FIG. 18 depicts an aspect of the method of FIGS. 12A and 12B in which charging is performed in accordance with plural modes selected by the user.

FIG. 19 depicts a mode of the method of FIGS. 12A and 12B in which power is returned to the utility grid.

FIG. 20 depicts a mode of the method of FIGS. 12A and 12B for sensing a power loss or outage of the utility grid and providing household backup power.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope.

### DETAILED DESCRIPTION

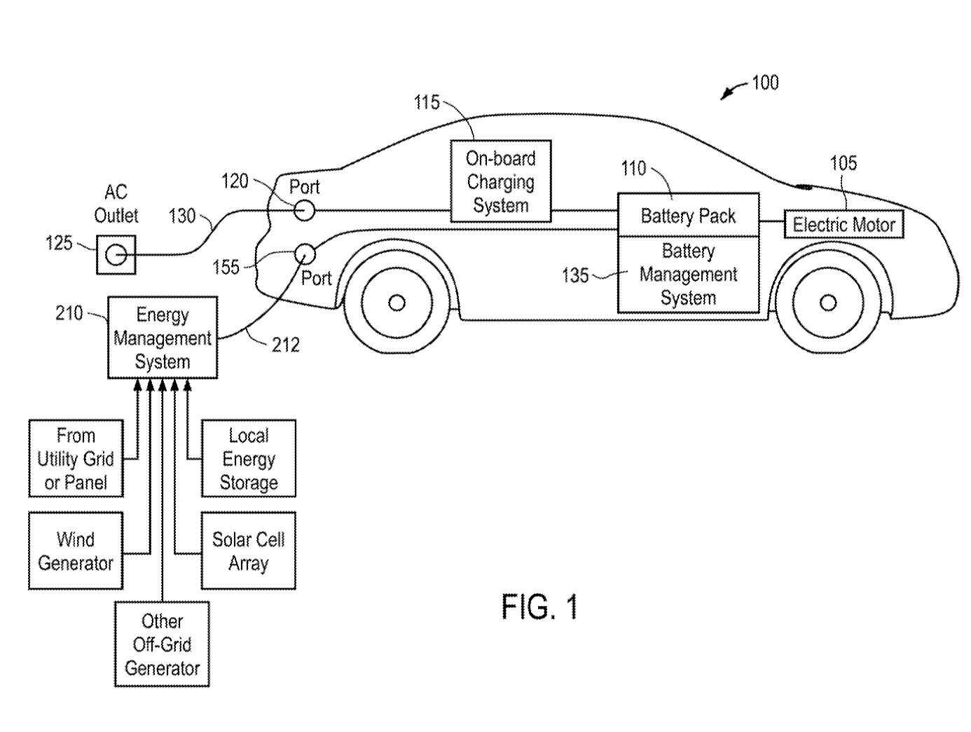

Referring now to FIG. 1, an electric vehicle 100 has an electric motor 105 coupled to the vehicle wheels and powered by an on-board EV battery pack 110 contained in the electric vehicle 100, or an alternative rechargeable energy storage device such as a capacitor bank, or fuel cell or the like. The battery pack 110 can be charged by an on-board charging system 115 that can be coupled through an external charging port 120 provided on the electric vehicle 100 to an A.C. electrical outlet 125 while the electric vehicle 100 is parked. A charging cable 130 can be temporarily plugged into the charging port 120 at one end and can be plugged into the A.C. electrical outlet 125 at the opposite end. The on-board charging system 115 transforms the A.C. power received from the outlet 125 to D.C. power at a voltage appropriate for charging the on-board EV battery pack 110. The voltage of the D.C. power supplied by the on-board charging system 115 to the on-board battery pack 110 may be approximately 480 volts DC or in a range of 250-480 volts DC, for example. A battery management system 135 can monitor the condition of the on-board battery pack 110, including battery temperature and charge level, and signals the on-board charging system 115 to stop charging whenever the battery pack 110 reaches a fully charged condition or whenever the battery temperature exceeds a predetermined limit, for example. The A.C. outlet 125 may be a 110 volt outlet or a 220 volt outlet, for example. In these cases, the charging port 120 may be implemented with a connector meeting the SAE J1772 specification for Level 1 (110 volt) and/or Level 2 (220 volt) sources.

As discussed above, the on-board charging system 115 can charge the battery pack 110 at a rate that is limited by the capacity (maximum charging rate or current-carrying capacity) of the on-board charging system 115. This capacity can be limited in order to reduce the size and weight of the on-board charging system 115. Moreover, the charging rate is limited by the power rating of the AC outlet 125. Such limitations have the undesirable effect of increasing the amount of time required to completely recharge the on-board battery pack 110.

In accordance with one embodiment, an energy management system 210 can be provided at the location (garage or car port) where the electric vehicle 100 is parked when not in use, and can provide electrical power to re-charge the on-board battery pack 110 through a detachable power cable 212. The energy management system 210 can be separate from the electric vehicle 100 and can manage power from numerous local sources, including power from the utility grid received through the household electric panel. The local sources can include renewable energy sources such as a wind-driven electric generator and/or a solar cell array or other off-grid electricity generator. The local energy sources may also include a local energy storage device such as an array of rechargeable batteries. The energy management system 210 furnishes D.C. current at the required battery charging voltage directly to the battery pack 110, bypassing the on-board charging system 115. This permits the battery pack 110 to be charged at the maximum rate allowed by the battery management system 135, unlimited by the capacity of the on-board charging system 115. The energy management system 210 may be coupled to the battery pack 110 via a detachable charging cable 212 through a charging port 155 adapted for a high voltage (e.g., 480 volts), for example. The on-board charging system 115 would be used in circumstances where the energy management system 210 is not available. Therefore, vehicle weight may be reduced by reducing the weight and power capacity of the on-board charging system 115 (or possibly eliminating it altogether). This represents a less complex system, because on-board chargers have more stringent specifications than off-board devices (devices not on the vehicle), such as off-board energy storage devices or AC/DC converters which can replicate the function of an on-board charger. The less complex system thus represents a lower total cost solution.

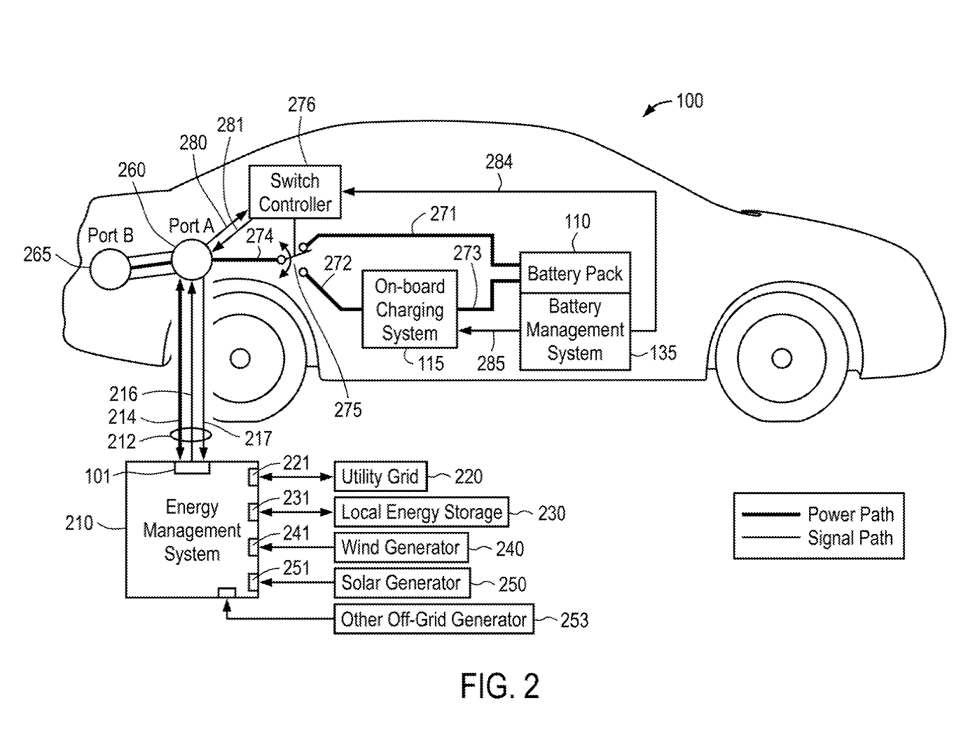

FIG. 2 depicts an embodiment in which information and control signal paths are provided within the electric vehicle 100 and within the charging cable 212 to enhance operation of the energy management system 210. In the embodiment depicted in FIG. 2, the charging cable 212 can be removably connected between the charging port 260 or 265 provided on the electric vehicle 100 and vehicle connector port 101 provided on the energy management system 210. The energy management system 210 is further coupled to receive power from any or all of the following sources: a utility grid 220 (e.g., via an electric power outlet), a local energy storage device 230 (which may be a battery array), a wind turbine electric generator 240 (“wind generator”), and a solar cell array electric generator 250 (“solar generator”) and/or an other off-grid electricity generator 253. For convenience, the energy management system 210 can have the following individual connector ports at which one end of a cable 212 may be removably connected: a utility grid connector port 221 connectable to the utility grid 220, a local energy storage device connector port 231 connectable to the local energy storage device 230, a wind generator connector port 241 connectable to the wind generator 240, and a solar generator connector port 251 connectable to the solar generator 250.

In the embodiment of FIG. 2, the two different charging ports 260, 265 provided on the vehicle have different power capacities. For example, the charging port 260 (“port A”) may be a Level 3 port capable of receiving 480 volts DC, while the charging port 265 may be a combination Level 1 and Level 2 port adapted to receive either 110 volts or 220 volts. The charging cable 212 may include a power conductor 214 and signal paths 216, 217, for example. The role of the signal paths 216, 217 will be discussed below.

The electric vehicle 100 in the embodiment of FIG. 2 can have dual paths for the electric charging current, namely a high current path 271 directly coupled to the on-board battery pack 110 and bypassing the on-board charging system 115, and a low current path 272 coupled to the on-board charging system 115. An output power path 273 is coupled from the on-board charging system 115 to the battery pack 110. Power from either charging port 260, 265 flows in a common power path 274 to a switch 275. The switch 275 can select one of the two power paths 271, 272 for power flowing from the charging port 260 (or from the charging port 265). A switch controller 276 responds to a bypass signal transmitted from the energy management system 210. The bypass signal indicates the presence of the energy management system 210. The switch controller 276 responds to the bypass signal by configuring the switch 275 to couple power from the port 260 (or from the port 265) to the high current power path 271 that bypasses the on-board charging system 115. In absence of the bypass signal, the switch controller 276 configures the switch 275 to select the low current power path 272.

The switch controller 276 is coupled at the charging port 260 (or at the charging port 265) to the signal paths 216, 217 through signal paths 280, 281 extending between the charging port 260 and the switch controller 276. A charging control signal path 284 extends from the battery management system 135 to the switch controller 276 while another charging control signal path 285 extends from the battery management system 135 to the on-board charging system 115. (Alternatively, the signal path 284 may extend directly from the battery management system 135 to the charging port 260 or 265.) The charging control signal carried on each charging control signal path 284, 285 indicates whether charging is allowed (depending upon battery charge level and temperature sensed by the battery management system 135). The energy management system 210 receives the charging control signal via the signal paths 284, 281 and 217. The bypass signal from the energy management system 210 follows the signal paths 216 and 280.

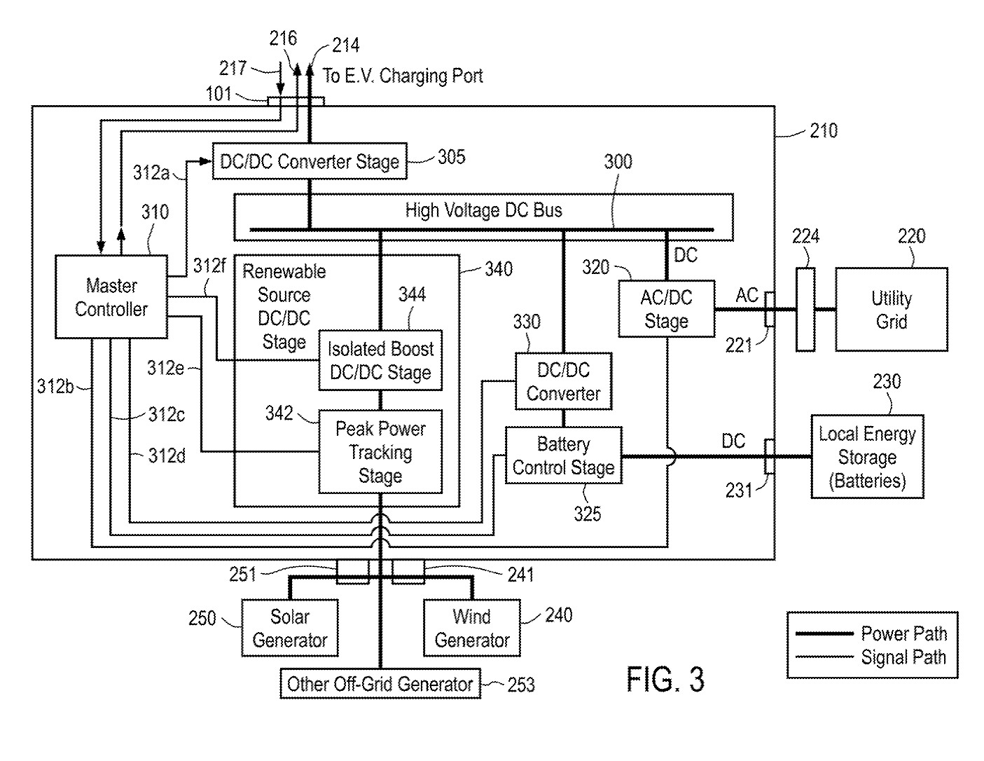

FIG. 3 is a diagram of the energy management system 210 of FIG. 2. A high voltage DC bus 300 can be coupled through intelligently controlled electrical conversion modules to the utility grid 220, the local energy storage device 230, the wind generator 240 and the solar generator 250 and/or the other off-grid electricity generator 253. The voltage of the DC bus 300 can be predetermined, and may be lower than the voltage required for charging the on-board battery pack 110. A DC/DC converter electrical conversion module 305 can raise the voltage supplied by the high voltage DC bus 300 to the charging voltage required to charge the on-board battery pack 110 before it is delivered to the charging port (260 or 265) of the electric vehicle 100 of FIG. 2.

Power flow through the charging port (260 or 265) may be bi-directional, so that in some instances (to be described below), power may flow from the on-board battery pack 110 to the high voltage DC bus 300. In such a case, the DC/DC converter electrical conversion module 305 reduces the DC voltage supplied from the on-board battery pack 110 down to the DC voltage of the high voltage DC bus 300. The direction of current flow may be controlled by providing a small suitable voltage difference, e.g., between the battery pack 110 and the high voltage D.C. bus 300. Current flow will be towards the lower potential. This may be implemented by the DC/DC converter 305, for example, in accordance with known techniques. The DC/DC converter electrical conversion module 305 may be intelligently controlled by a master controller 310 via a signal path 312a. In one embodiment, the master controller 310 can be a programmable controller that can transmit a control signal via the signal path 312a to a control input of the DC/DC converter electrical conversion module 305. The control signal may be a command to admit current or another command to halt current flow in the DC/DC converter electrical conversion module 305.

The utility grid 220 can be coupled to the high voltage DC bus 300 via an AC/DC electrical conversion module 320. The AC/DC electrical conversion module 320 provides conversion from AC to DC power for power flow in one direction, and conversion from DC power to AC power for power flow in the opposite direction. Power flow through the AC/DC electrical conversion module 320 may be bi-directional. For power flowing from the utility grid 220 to the high voltage DC bus 300, the AC/DC electrical conversion module 320 converts AC power to DC power and raises the voltage to the DC voltage of the high voltage DC bus 300. For power flowing from the high voltage DC bus 300 to the utility grid 220, the AC/DC electrical conversion module 320 converts DC power at the voltage of the high voltage DC bus 300 to AC power at the voltage of the utility grid 220. Current flow direction will be toward the lower potential. This may be implemented by the AC/DC electrical conversion module 320. The AC/DC electrical conversion module 320 may be intelligently controlled by the master controller 310 via a signal path 312b to a control input of the AC/DC electrical conversion module 320. The AC/DC electrical conversion module 320 may block or conduct current flow in response to control signals from the master controller 310. The signal path 312b may be bi-directional, in which case the AC/DC electrical conversion module 320 may transmit information back to the master controller 310 confirming its present status and/or conditions.

The local energy storage device 230 (e.g., an array of batteries or fuel cells or capacitors, etc.) can be coupled to the high voltage D.C. bus 300 through a battery control electrical conversion module 325 and a DC/DC converter electrical conversion module 330. The battery control electrical conversion module 325 and the DC/DC converter electrical conversion module 330 may be bi-directional, and may be intelligently controlled by the master controller 310 via signal paths 312c and 312d extending to control inputs of the battery control electrical conversion module 325 and the DC/DC converter electrical conversion module 330, respectively. The direction of current flow may be established by providing a small suitable voltage difference between the energy storage device 230 and the high voltage D.C. bus 300, in accordance with known techniques. Current flow will be in the direction of lower voltage. This may be implemented by DC/DC converter electrical conversion module 330, for example. The battery control electrical conversion module 325 may monitor and control, via the signal path 312c, charging of the local energy storage device 230 based upon charge level and battery temperature, while informing the master controller 310 of its present status or condition of the local energy storage device 230. The battery control electrical conversion module 325 also monitors and controls discharging of the local energy storage device 230, and/or informs the master controller 310 whether the battery charge level is sufficient to charge the on-board battery pack 110 of the electric vehicle 100.

For power flowing from the local energy storage device 230 to the high voltage DC bus 300, the DC/DC converter electrical conversion module 330 boosts the DC voltage furnished by the local energy storage device 230 to the DC voltage level of the high voltage DC bus 300. For power flowing from the high voltage DC bus to the local energy storage device 230, the DC/DC converter electrical conversion module 330 reduces the high DC voltage supplied by the high voltage DC bus 300 down to a DC voltage near the battery voltage of the local energy storage device 230. This DC voltage may slightly exceed the battery voltage of the local energy storage device by an amount sufficient to efficiently charge the batteries of the local energy storage device 230.

Renewable energy sources, such as the wind generator 240 and/or the solar generator 250 are coupled to the high voltage DC bus through a renewable source DC/DC electrical conversion module 340. While FIG. 3 depicts an embodiment in which the renewable source DC/DC electrical conversion module 340 can be shared between the wind generator 240 and the solar generator 250, plural renewable energy source DC/DC electrical conversion modules may be provided so that each one of the renewable energy sources (e.g., the wind generator 240, the solar generator 250 and/or the other off-grid electricity generator 253) interfaces with the high voltage DC bus 300 through an individual DC/DC electrical conversion module. Power flow through the renewable source DC/DC electrical conversion module 340 is in one direction only, i.e., toward the high voltage DC bus 300. The renewable source DC/DC electrical conversion module 340 may include a peak power tracking electrical conversion module 342 and an isolated boost DC/DC electrical conversion module 344, intelligently controlled by the master controller 310. This control may be exercised over signal paths 312e and 312f extending to control inputs of the power tracking electrical conversion module 342 and of the isolated boost DC/DC electrical conversion module 344, respectively. The peak power tracking electrical conversion module 342 employs conventional techniques for selecting an optimum power level at which to operate respective ones of the renewable energy sources 240, 250. The peak power tracking electrical conversion module 342 further informs the master controller 310 of the power output of each renewable energy source 240, 250, indicating whether adequate power is available from each one.

The master controller 310 can be programmed to intelligently manage each of the energy storage devices (the on-board battery pack 110 and the local energy storage device 230) and each of the energy sources (the utility grid 220 and the renewable energy sources including the wind generator 240 and the solar generator 250) so as to optimize efficiency while minimizing energy cost. For example, the master controller 310 causes the local energy storage device 230 to be charged from the renewable energy sources 240, 250, if available, when the electric vehicle 100 is absent (or unconnected). Alternatively, the master controller 310 causes the local energy storage device 230 to be charged from the utility grid if the grid is at low demand rate at the current time, or if the renewable energy sources 240, 250 are currently unavailable or unproductive. The master controller 310 may undertake a complex decision based upon the current demand rate on the utility grid, the present power output levels of the renewable energy sources 240, 250, and the amount of time available to fully charge the renewable energy source. The master controller 310 also decides which energy source to use to charge the on-board battery pack 110 when the electric vehicle 100 is present. Thus, the fastest charging of the on-board battery pack 110 can be obtained from the local energy storage device 230 if the local energy source 230 is sufficiently charged. This rate may greatly exceed the rate at which the local energy storage device 230 is charged from the renewable energy sources such as the wind generator 240 or the solar generator 250. If for some reason the local energy storage device 230 is not sufficiently charged, then the master controller 310 decides which of the other sources (the utility grid 220, the wind generator 240 or the solar generator 250) would be best to use to charge the on-board battery pack 110, depending upon the present demand rate of the utility grid 220 and the respective output power levels of the wind generator 240 and the solar generator 250. The master controller 310 may employ more than one of those sources simultaneously to charge the on-board battery pack 110 when the electric vehicle 100 is present, or to charge the local energy storage device 230 when the electric vehicle 100 is unconnected or absent.

In one embodiment, the master controller 310 can configure the internal electric power or current flow paths within the energy management system 210 by issuing different control signals to selected ones of the different electrical conversion modules, such as the DC/DC electrical conversion module 305, the AC/DC electrical conversion module 320, the battery control electrical conversion module 325, the DC/DC converter electrical conversion module 330, the peak power tracking electrical conversion module 342 and/or the isolated boost electrical conversion module 344. The individual control signals enable or disable current flow through the respective electrical conversion modules and establish a desired direction of current flow in those paths where current may flow in either direction (bidirectional). By individually enabling and disabling current flow through respective electrical conversion modules, the master controller 310 can cause current to flow exclusively between selected ones of the connector ports of the energy management system 210, including the vehicle connector port 101, the utility grid connector port 221, the local energy storage device connector port 231, the wind generator connector port 241 and the solar generator connector port 251.

In order to charge the on-board battery pack 110 from the local energy storage device 230, current or power flows via the high voltage DC bus 300 from the local energy storage connector port 231 to the vehicle charging connector port 101. In this case, the master controller 310 enables current flow through the battery control electrical conversion module 325, the DC/DC converter electrical conversion module 330 and the DC/DC converter electrical conversion module 305.

In order to charge the local energy storage device 230 from the wind generator 240 or from the solar generator 250, current or power flows via the high voltage DC bus 300 from either of the renewable source connector ports 241 or 251 to the local energy storage connector port 231. In this case, the master controller 310 enables current flow through the battery control electrical conversion module 325, through the DC/DC converter electrical conversion module 330, through the peak power tracking electrical conversion module 342 and through isolated boost DC/DC electrical conversion module 344.

In order to charge the local energy storage device 230 from the utility grid 220, current or power flows via the high voltage DC bus 300 from the utility grid connector port 221 to the local energy storage connector port 231. In this case, the master controller 310 enables current flow through the battery control electrical conversion module 325, the DC/DC converter electrical conversion module 330 and the AC/DC electrical conversion module 320.

The master controller 310 may be further programmed to supply excess or unneeded electric power to the utility grid 220. For example, if one or both of the renewable energy sources 240, 250 is producing a sufficient level of electric power, or if the on-board battery pack 110 is fully charged, or if the local energy storage device 230 is fully charged, then the master controller 310 may decide to apportion power from any one or all of these sources to return power back to the utility grid 220, and earn a credit from the utility power supplier.

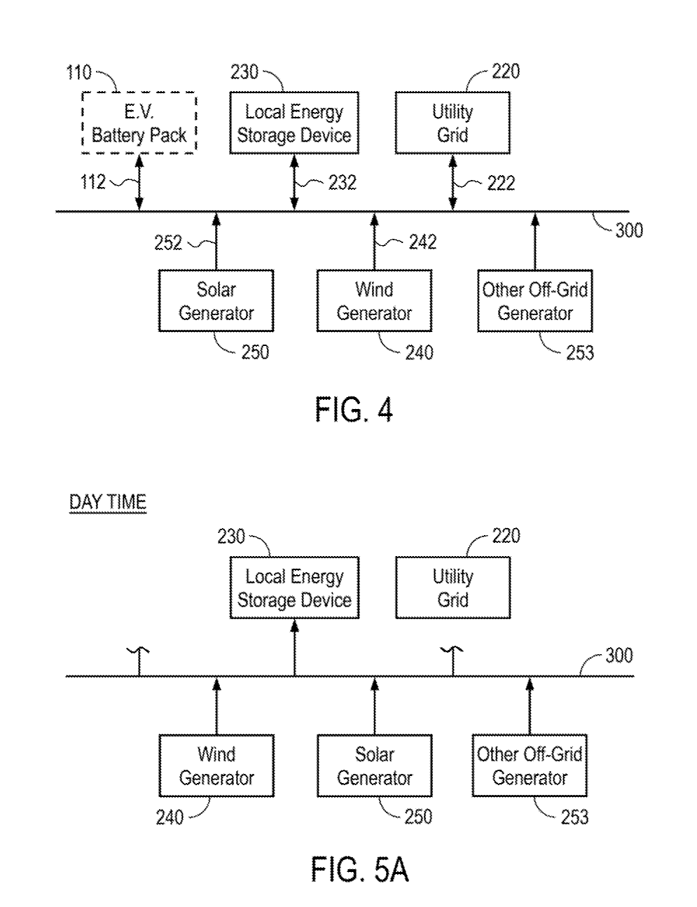

FIG. 4 depicts the use of the high voltage D.C. bus 300 in the manner of an energy pool, in which power may flow simultaneously in either one of two directions between the high voltage D.C. bus 300 and the electric vehicle battery pack 110, the local energy storage device 230 and the utility grid 220. Power flows in only one direction from the wind generator 240 to the high voltage D.C. bus 300 and from the solar generator 250 to the high voltage D.C. bus 300. Power flow between each of the energy sources 110, 220, 230, 240 and 250 and the high voltage D.C. bus 300 is shown schematically as following respective power paths 112, 222, 232, 242 and 252. Many or all of these power paths may conduct power simultaneously, and in one embodiment may be constantly conducting power. The current flow and direction of current flow will depend upon the relative abundance of power or need for power of the respective energy sources 110, 220, 230, 240, 250. In this manner of operation, the high voltage D.C. bus 300 acts as a pool of energy, to which excess energy can be supplied by some sources while other sources withdraw energy from the pool. The direction of current flow in the paths 112, 222 and 232 may change, as some sources become fully charged or depleted, or where power can be returned to the utility grid 220 rather than being withdrawn from it.

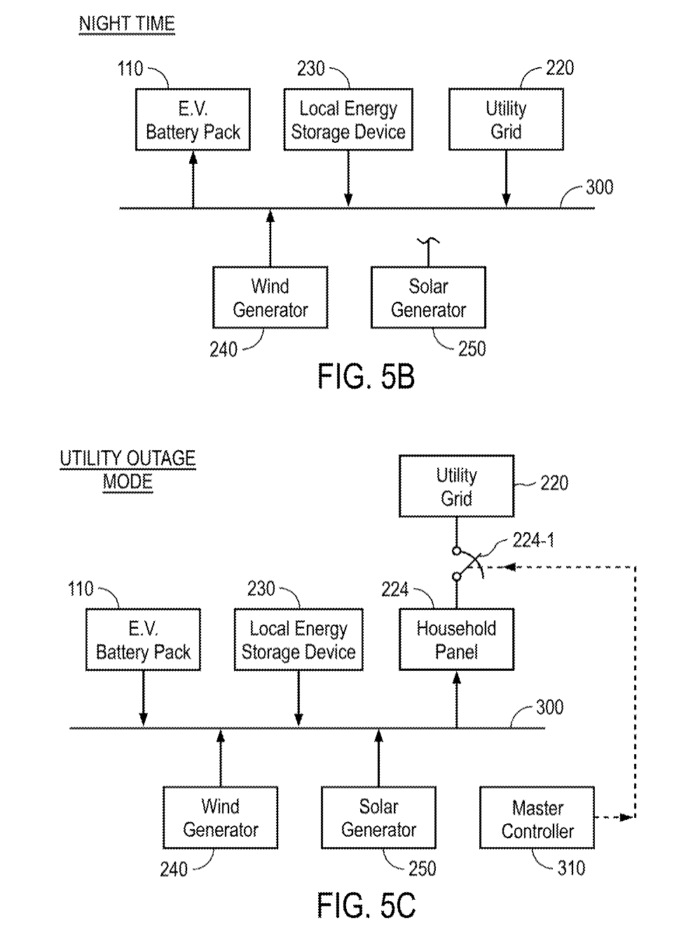

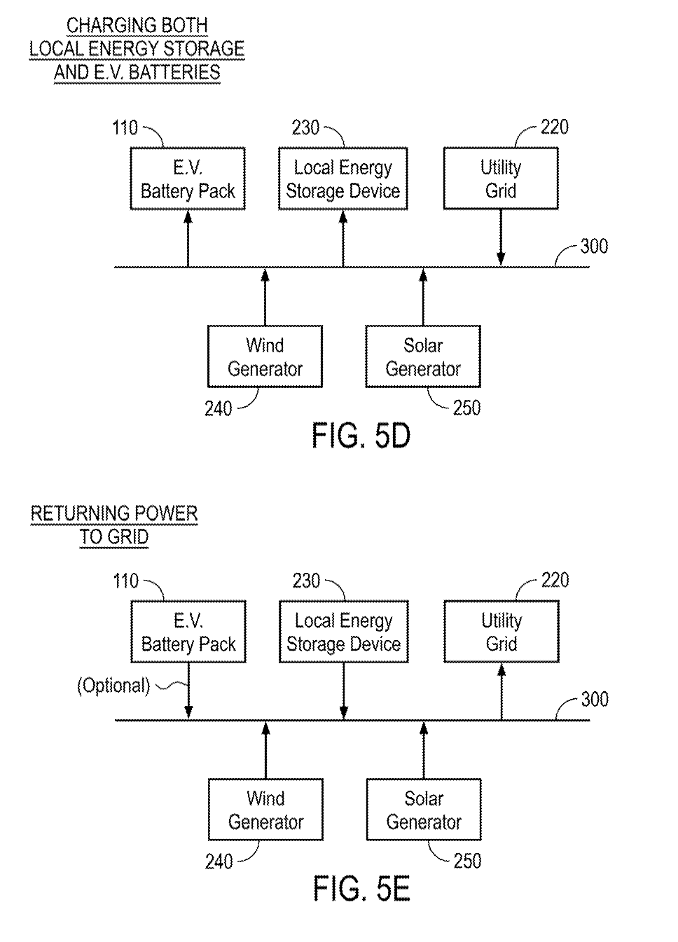

FIGS. 5A through 5E depict different cases in which power flow is enabled only through selected ones of the paths 112, 222, 232, 242 and 252. In the case of FIG. 5A, the electric vehicle 100 is absent, and the local energy storage device 230 can be charged from the renewable energy sources 240 and 250 while minimizing cost by refraining from charging the local energy storage device 230 from the utility grid 220. The case of FIG. 5A may be typical of a daytime use.

FIG. 5B depicts a case in which the electric vehicle battery pack 110 can be charged by drawing power from the local energy storage device 230 and from the wind generator 240 (the solar generator 250 is shown not producing power, such as is typically the case at night). In addition, and if required, the battery pack 110 may be charged by drawing power from the utility grid 220. The case of FIG. 5B may be typical of a nighttime use.

FIG. 5C depicts a case in which the high voltage bus 300 is used to supply backup power to the household when the utility grid 220 experiences a power outage or blackout. As indicated in FIG. 5C, the utility grid 220 is coupled to the high voltage bus 300 through an electric utility panel 224 having a main switch 224-1 that interrupts connection to the utility grid 220. The main switch 224-1 in the embodiment of FIG. 5C does not interrupt the connection between the electric utility panel 224 and the high voltage D.C. bus 300. In the event of a power outage on the utility grid 220, the main switch 224-1 is opened (e.g., under control of the master controller 310 of FIG. 3) and backup power for the household flows to the utility panel 224 from the local energy storage device 230, and from either or both of the wind generator 240 and the solar generator 250, depending upon their output power levels. In addition, if authorized by the user, backup power may also be withdrawn from the electric vehicle battery pack 110.

FIG. 5D depicts a case in which the high voltage bus 300 is used to simultaneously charge both the battery pack 110 and the local energy storage device 230 from all available sources, including the utility grid 220, the wind generator 240 and the solar generator 250.

FIG. 5E depicts simultaneous power flow from the local energy storage device 230, the wind generator 240 and the solar generator 250 to return power to the utility grid 220. Optionally, power may also be returned to the utility grid 220 from the battery pack 110.

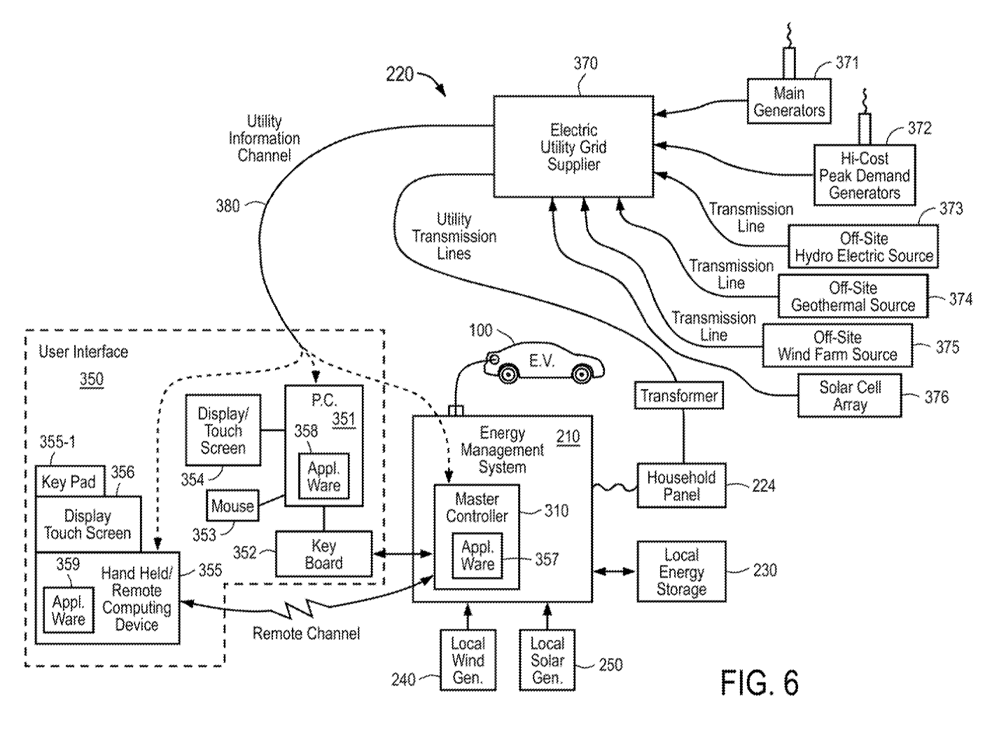

Referring now to FIG. 6, the energy management system 210 may include or be connected to a user interface 350. The user interface 350 can be connected to the master controller 310, and in one embodiment may be a computer, such as a personal computer 351 having a keyboard 352, a mouse 353 and a display 354 which may be a touch screen. Alternatively, or in addition, the user interface 350 may include a handheld or remote personal Computing device 355 with its own display 356. The remote personal computing device 355 may be a cell phone or a smart phone, for example. The display 356 of the remote personal computing device 355 may be a touch screen, for example. The remote personal computing device may include a keypad 355-1.

The methods described below in this specification may be implemented by an application program 357 (in the form of firmware or software) stored in a memory of the master controller 310, and executed by the master controller 310. In addition, the personal computer 351 may also contain an application program 358 that enables the personal computer 351 to function as the user interface of the master controller 310, by providing prompts to the user, graphical displays of system information and respond to commands or inputs from the user, in accordance with the methods described herein. Alternatively, or in addition, the remote personal computing device 355 may contain an application program 359 that enables the remote personal computing device 355 to function as a user interface of the master controller 310, by providing prompts to the user, graphical displays of system information and respond to commands or inputs from the user.

In the foregoing, the application program that implements the methods described herein is described as being the application program 357 that is stored in and executed by the master controller 310. In an alternative embodiment, such software may be included in the application program 358 in the personal computer 351, with personal computer 351 performing some or all of the tasks by controlling the master controller 310. Similarly, in another alternative embodiment, such software may be included in the application program 359 resident in the remote personal computing device 355, with the remote personal computing device 355 performing some or all of the tasks by controlling the master controller 310.

FIG. 6 further depicts the utility grid 220 as including an electric grid supplier 370 having main electric power, generators 371 and an array of smaller electric energy sources that are high-cost peak demand electric power generators 372 (hereinafter referred to as peak demand generators), which are kept off-line until a peak in utility customer energy demand occurs. In addition, various remote “green” sources of electrical energy are available to the electric utility grid supplier 370 via long power transmission lines, including a hydroelectric source 373, a geothermal source 374, a wind farm electric generator source 375 and a solar cell array electric source 376.

The electric utility grid supplier 370 can change the price per kilowatt hour of electricity (utility rate) anytime during each day, depending upon the user demand. For example, at peak demand, the high cost peak demand generators 372 must be brought on line, thus making it more expensive to provide energy, so that the utility rate is increased at that time. Depending upon availability and other factors, the utility grid supplier 370 may be able to draw energy from any one of the green sources 373, 374, 375 and 376, and change the fraction of the total energy provided by the green energy sources. In order to keep the customer informed of all such changes, a utility information communication channel 380 is provided that carries the latest information concerning the current utility rate and the current fraction of the energy contributed by green sources (“green fraction”). The master controller 310 or the personal computer 351 or the remote personal computing device 355 may be connected or coupled to the utility information channel 380. The utility information channel 380 may be implemented on the internet or it may be implemented as a local area network or as a signal carried on the power transmission lines or as a dedicated conductor or coaxial cable provided by the utility.

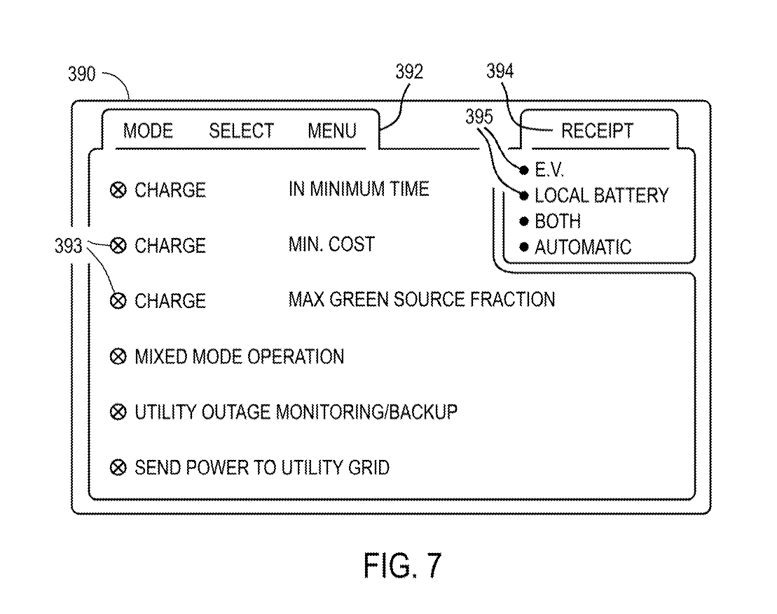

FIG. 7 illustrates one example of a menu window 390 displayed as a graphical user interface on the display 354 of the personal computer 351 or on the display 356 of the remote personal computing device 355 under control of one of the application programs 357 or 358 or 359.

The menu window 390 includes a mode select drop-down menu 392, in which the user can select the mode of operation from among a list of modes presented in the mode select drop-down menu 392. The illustrated drop-down menu depicts modes that can be chosen, but does not contain an exhaustive list of all possible modes. The drop-down menu 392 includes buttons 393 that are labeled with the names of respective modes. A mode may be selected by clicking on the appropriate button 393 with a mouse or by touching the button 393 if the display 354 or 356 is a touch screen.

The menu window 390 further includes a recipient selection drop-down menu 394, in which the user can select which one of the rechargeable energy sources (i.e., the battery pack 110 or the local energy storage device 230) is to be the recipient of the energy delivered via the high voltage bus 300. The illustrated drop-down menu depicts key sources that can be chosen. The drop-down menu 394 includes buttons 395 that are labeled with the name of a respective rechargeable source. A source may be selected as the recipient by clicking on the appropriate hot button 395 with a mouse or by touching the button if the display is a touch screen.

Any one of the application programs 357, 358 or 359 may include operational instructions or subroutines that optimize all energy sources in various modes. Although execution of such instructions will be described as being carried out by the master controller 310, it is understood that they may be carried out by the personal computer 351, or the remote personal computing device 355, or a combination of them.

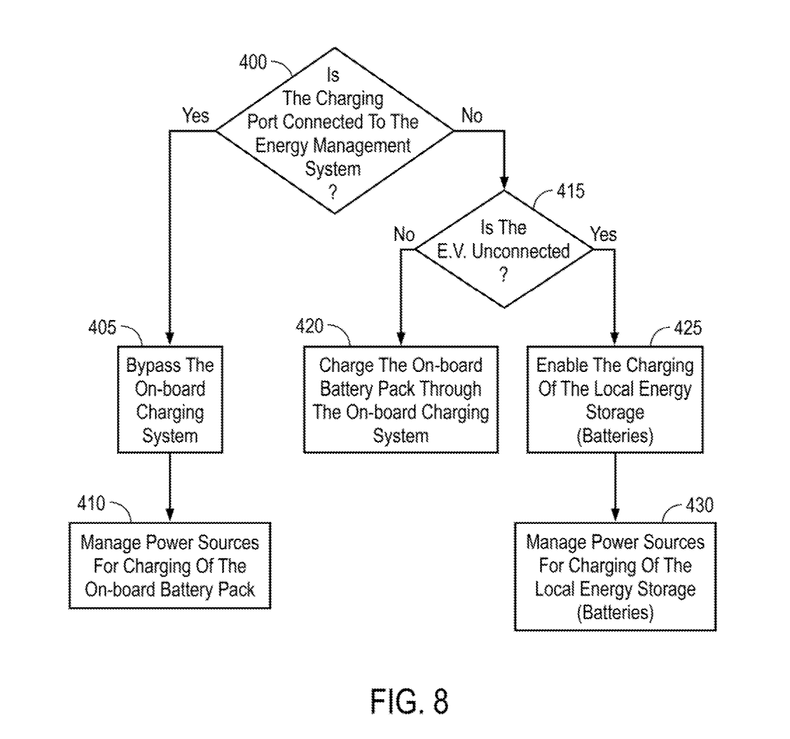

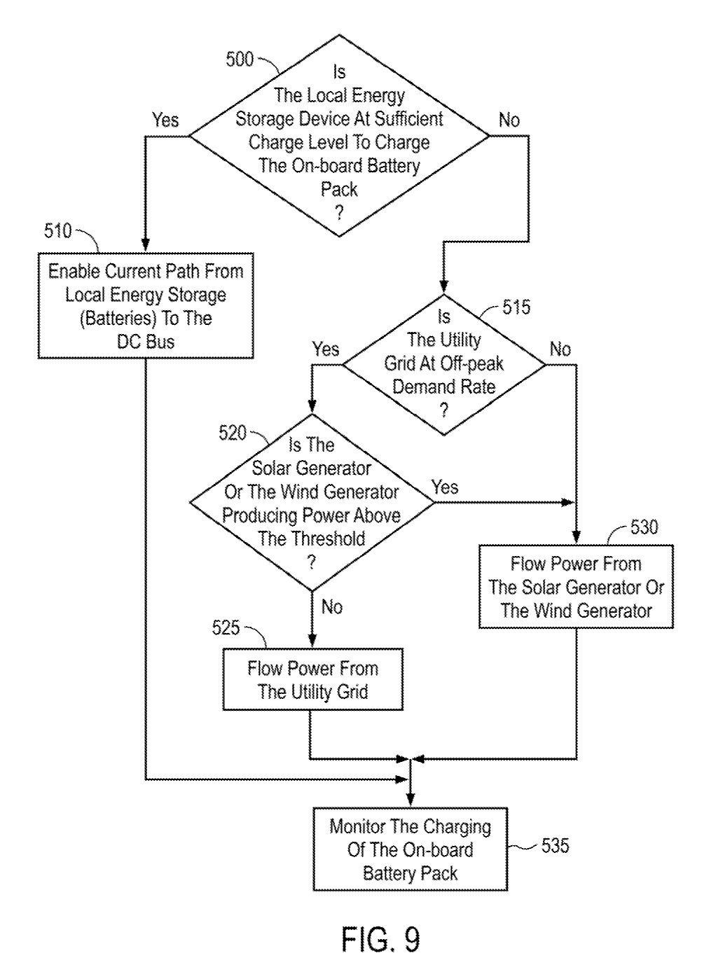

One example of operation of the master controller 310 is depicted in FIG. 8. The master controller 310 first determines whether either of the utility vehicle charging ports 260 or 265 is connected to the energy management system 210 (block 400 of FIG. 8). This determination may be made by the master controller 310 sensing the presence of a flag signal transmitted by the electric vehicle 100 via the charging port 260 or 265. If the charging port is connected (YES branch of block 400), then the master controller 310 commands the switch controller 276 to configure the switch 275 in the bypass position so that energy flows directly to the on-board battery pack 110 (block 405 of FIG. 8). Thereafter, the master controller 310 manages all the energy sources referred to above so as to optimize efficiency in charging the on-board battery pack 110 (block 410 of FIG. 8). The management operation of block 410 is illustrated in detail in FIG. 9, and is described below. This operation continues until a change in condition occurs, such as the on-board battery pack 110 reaching full charge, which is signaled to the master controller 310 by the battery management system 135.

If the charging port 260 of the electric vehicle 100 is not connected to the energy management system 210 (NO branch of block 400), then the master controller 310 determines whether the electric vehicle 100 is completely unconnected (block 415 of FIG. 8). If not (NO branch of block 415), this means that the electric vehicle 100 is connected in the manner depicted in FIG. 1 to charge the on-board battery pack 110 through the on-board charging system 115. This charging may be continued to completeness (block 420 of FIG. 8).

If either of the electric vehicle charging ports 260 and 265 is unconnected to the energy management system 210 (YES branch of block 415), then any or all energy sources may be utilized to re-charge the local energy storage device 230. In this case, the master controller 310 enables charging of the local energy storage device 230 (block 425). The master controller 310 manages all energy sources to optimize efficiency in charging the local energy storage device 230 (block 430 of FIG. 8).

The management operation of block 410 for charging the on-board battery pack 110 will now be described with reference to FIG. 9. The first step is for the master controller 310 to determine whether the local energy storage device 230 contains sufficient charge for charging the on-board battery pack 110 (block 500 of FIG. 9). This information may be obtained from the battery control electrical conversion module 325 of FIG. 3. If the local energy storage device 230 is sufficiently charged (YES branch of block 500), then the master controller 310 enables current to flow from the local energy storage device 230 to the high voltage D.C. bus 300 (block 510). In order to avoid incurring utility costs, this selection may be rendered exclusive by blocking the power path from the utility grid 220 to the high voltage DC bus 300.

If the local energy storage device 230 is not sufficiently charged (NO branch of block 500), then the master controller 310 determines whether the utility grid 220 is at an off-peak demand rate (block 515). This determination may be made by referring to a published schedule of utility rates, or by real time electronic inquiry via a smart utility grid. If the utility grid 220 is not currently at an off-peak demand rate (NO branch of block 515), then the master controller 310 enables power flow from the wind generator 240 or the solar generator 250 (block 530), unless neither is producing sufficient power. If the utility grid 220 is currently at an off-peak demand rate (YES branch of block 515), then the master controller 310 determines whether either the wind generator 240 or the solar generator 250 is producing sufficient electric power to render it preferable to the costly utility grid 220 (block 520). This determination may be made by comparing the renewable source output power level to a predetermined power threshold, for example. If the power is sufficient (YES branch of block 520), then the master controller 310 enables power flow from the wind generator 240 or the solar generator 250 to the high voltage DC bus 300 (block 530). Otherwise (NO branch of block 520), the master controller 310 enables power flow from the utility grid 220 to the high voltage DC bus 300 (block 525). In this manner, the master controller 310 may explore numerous zero-cost or low-cost options before selecting utility grid power at a peak demand rate. During charging of the on-board battery pack 110, the master controller 310 continually monitors the charging conditions as indicated by the battery management system 135 (block 535).

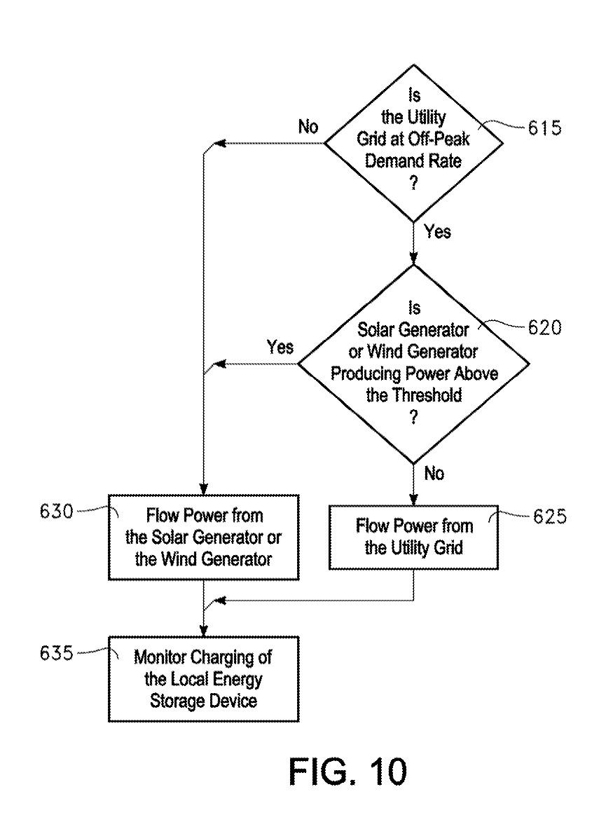

The management operation of block 430 for charging the local energy storage device 230 will now be described with reference to FIG. 10. The first step is for the master controller 310 to determine whether the utility grid 220 is at an off-peak demand rate (block 615). This determination may be made by referring to a published schedule of utility rates, or by real time electronic inquiry via a smart utility grid. If the utility grid 220 is not currently at an off-peak demand rate (NO branch of block 615), then the master controller 310 enables power flow from the wind generator 240 or the solar generator 250 (block 630), unless neither is producing sufficient power. If the utility grid 220 is currently at an off-peak demand rate (YES branch of block 615), then the master controller 310 determines whether either the wind generator 240 or the solar generator 250 is producing sufficient electric power to render it preferable to the costly utility grid 220 (block 620). If so (YES branch of block 620), then the master controller 310 enables power flow from the wind generator 240 or the solar generator 250 to the high voltage DC bus 300 (block 630). Otherwise (NO branch of block 620), the master controller 310 enables power flow from the utility grid 220 to the high voltage DC bus 300 (block 625). During charging of the local energy storage device 230, the master controller 310 continually monitors the charging conditions as indicated by the local battery control electrical conversion module 325 (block 635).

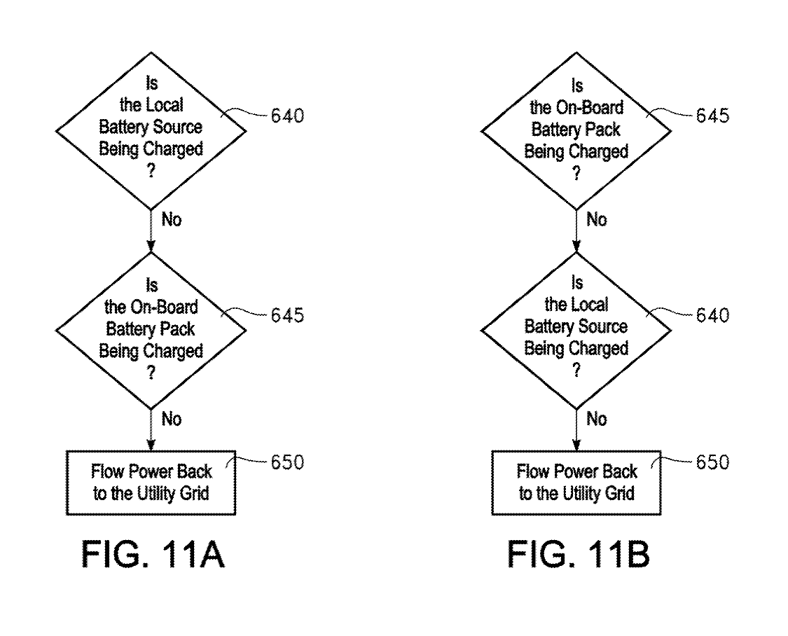

As described above, power flow may be bi-directional with respect to the utility grid 220, the local energy storage device 230 and the on-board battery pack 110. Thus, under favorable conditions detected by the master controller 310, if spare power is available, it may be returned to the utility grid 220. The decision may be implemented in the master controller 310 as depicted in FIG. 11A. If the local energy storage device 230 is not being charged (NO branch of block 640) and if on-board battery pack 110 is not being charged (NO branch of block 645), then the master controller 310 enables power flow from the high voltage DC bus 300 to the utility grid 220 (block 650). The power may be furnished from any one or all of the following, depending upon availability: the local energy storage device 230, the on-board battery pack 110, the wind generator 240, and/or the solar generator 250. FIG. 11B depicts a modification of the embodiment of FIG. 11A, in which the order of operation of blocks 640 and 645 is reversed from that depicted in FIG. 11A. In FIG. 11B, if the on-board battery pack 110 is not being charged (NO branch of block 645) and if the local energy storage device 230 is not being charged (NO branch of block 640, then the master controller 310 enables power flow from the high voltage DC bus 300 to the utility grid 220 (block 650).

The methods of FIGS. 8-11 enable the energy management system 210 to optimize the use of the energy sources including the rechargeable energy sources (the on-board battery pack 110 and the local energy storage device 230), the renewable energy sources (the wind generator 240 and the solar generator 250) and the utility grid 220 to minimize cost. Thus, when the on-board battery pack 110 is not being charged, the energy storage device 230 may be charged at a slow rate by a renewable energy source (the wind generator 240 or the solar generator 250) over many hours if necessary (depending upon local wind speed or solar radiation). After the local energy storage device 230 has been sufficiently charged, the on-board battery pack 110 of the electric vehicle may be charged at a very high rate by discharging the local energy storage device 230 to the on-board battery pack 110, to fully re-charge the on-board battery pack 110 in a relatively short time (e.g., within less than one hour). If the wind generator 240 and the solar generator 250 are not producing sufficient electrical power, the energy management system 210 may enable charging either (or both) the on-board battery pack 110 and/or the local energy storage device 230 from the utility grid 220. If the local energy storage device 230 or the on-board battery pack 110 or the wind generator 240 or the solar generator 250 are providing sufficient power, the energy management system 210 may divert such power to the utility grid 220.

The master controller 310 may be implemented as a programmed microprocessor that generates the required command signals described above to carry out the operations described above automatically. In addition, user control may be facilitated by including a user interface as a part of the master controller 310.

The energy management system 210 has been described as having plural electrical conversion modules, including the DC/DC converter electrical conversion module 305, the AC/DC electrical conversion module 320, the battery control electrical conversion module 325, the DC/DC converter electrical conversion module 330, the peak power tracking electrical conversion module 342 and the isolated boost DC/DC electrical conversion module 344. While each of these electrical conversion modules has been described with reference to a particular function, such as providing a conversion between different DC voltages, or a conversion between AC and DC power, for example, such functionality may be provided in other devices rather than being provided within the particular electrical conversion module, or may be unnecessary in some embodiments. In the disclosed embodiment, there is at least one electrical conversion module between each energy source (the utility grid 220, the local energy storage device 230, the wind generator 240 and the solar generator 250) and the high voltage bus 300, each electrical conversion module being responsive to a control signal from the master controller 310 to block or conduct current flow through the particular electrical conversion module.

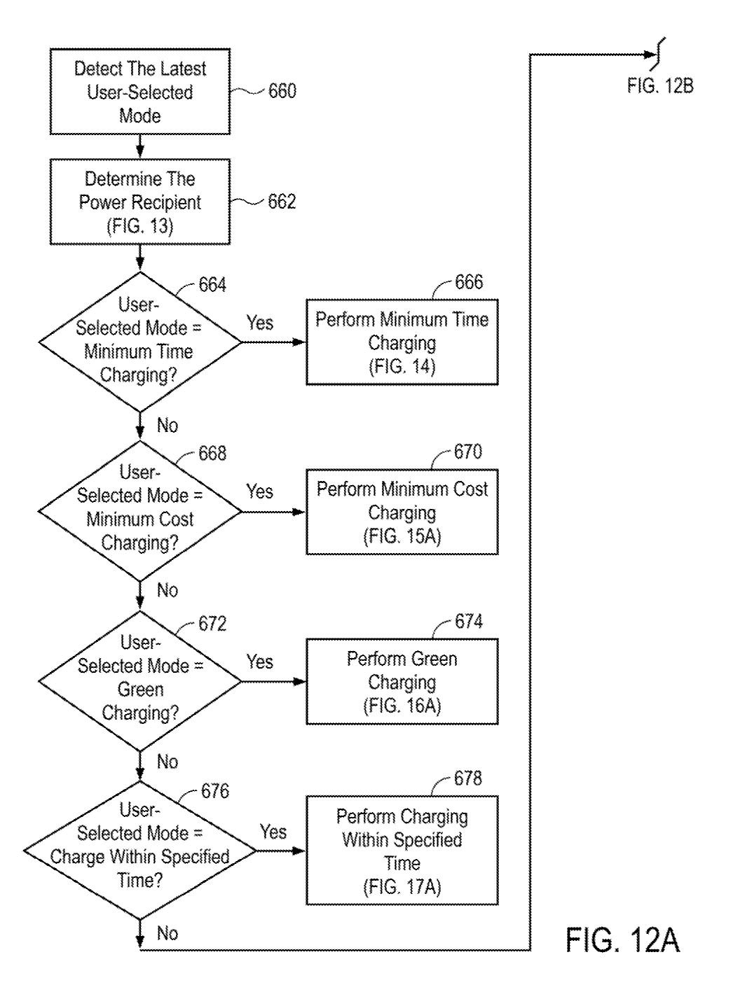

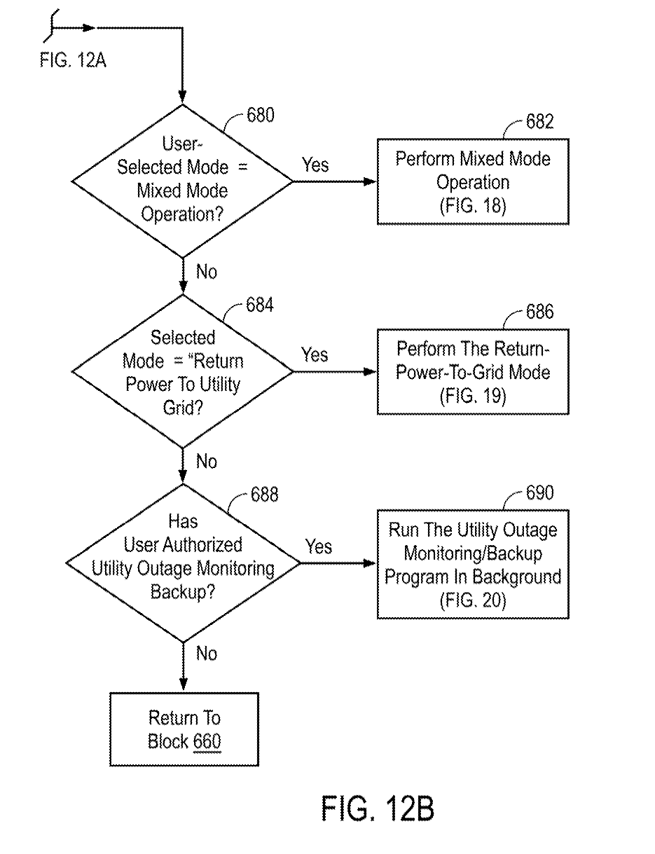

FIGS. 12A and 12B depict a method of operating the energy management system 210 in the complex environment of FIG. 6. In the method of FIGS. 12A and 12B, the application program is capable of operating the energy management system in any one of a number of different modes. These modes include a minimum time charging mode, a minimum cost charging mode, a green charging mode, a mode for charging within a specified time, operation based upon plural modes, a mode in which power is returned to the grid, and a power outage monitoring and backup mode. The operational elements of each mode will be described below. The user interface 350 enables the user to select any one mode or to prioritize among different modes. This may accomplished by displaying a menu window of the type depicted in FIG. 7, inviting the user to use the hot buttons in that window to select a mode. Almost all aspects of the method of FIGS. 12A and 12B, described below, involves a communication through the user interface 350.

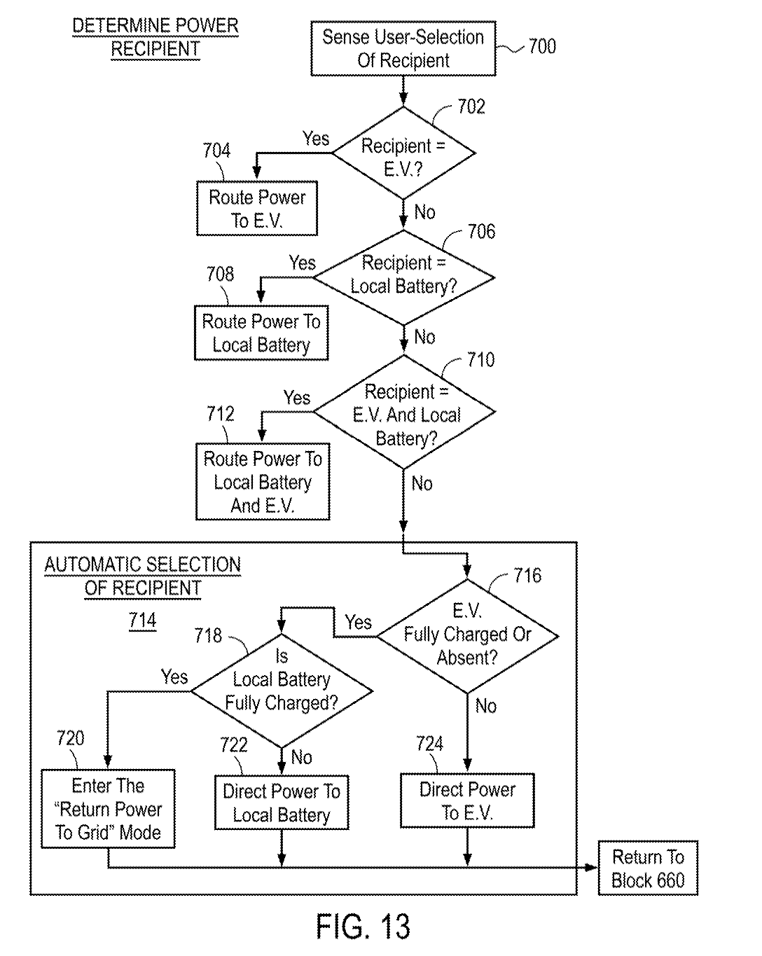

The method of FIGS. 12A and 12B begins by detecting the latest selection by the user of a mode (block 660 of FIGS. 12A and 12B). The next step is to determine the power recipient, namely the energy source to which power from the high voltage D.C. bus 300 of FIG. 3 is to be directed (block 662 of FIGS. 12A and 12B). An embodiment of the operation of block 662 is depicted in FIG. 13. discussed later herein.

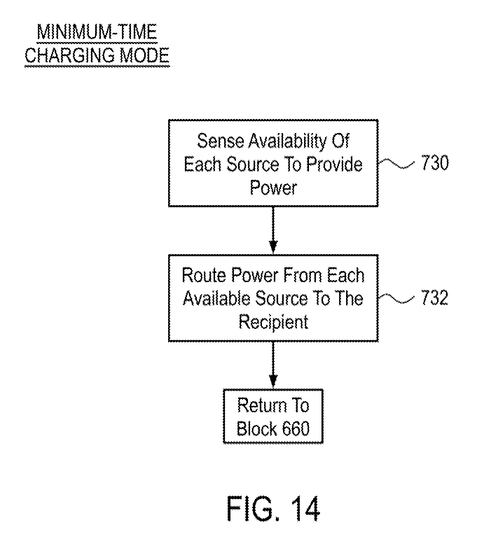

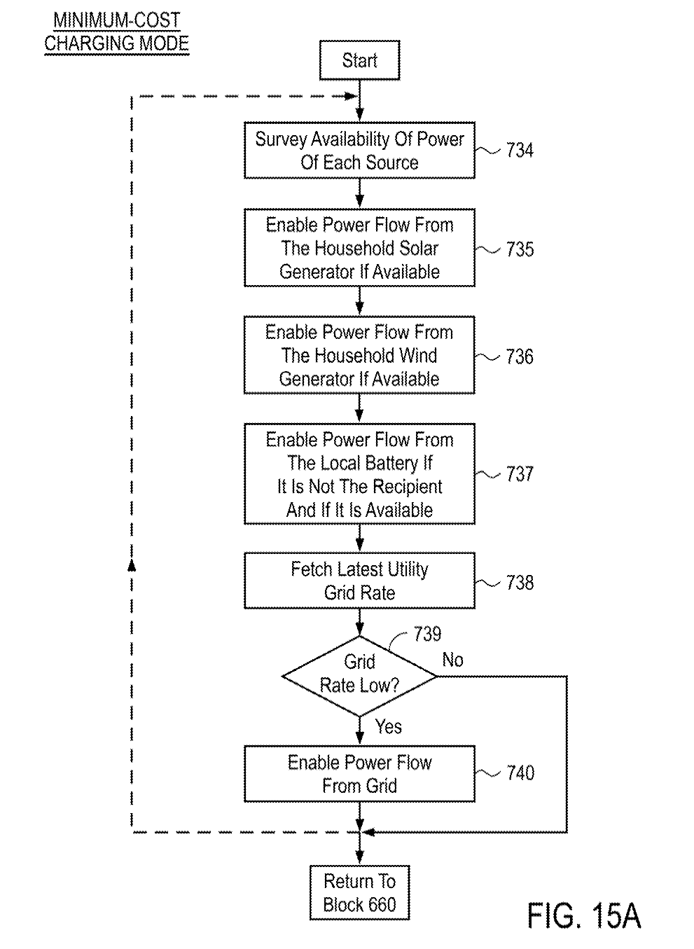

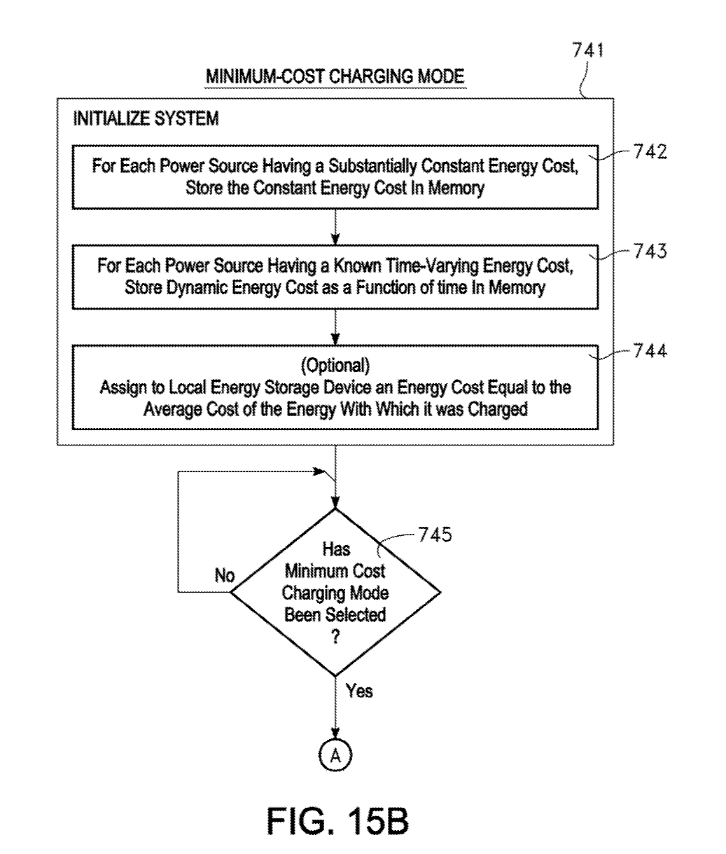

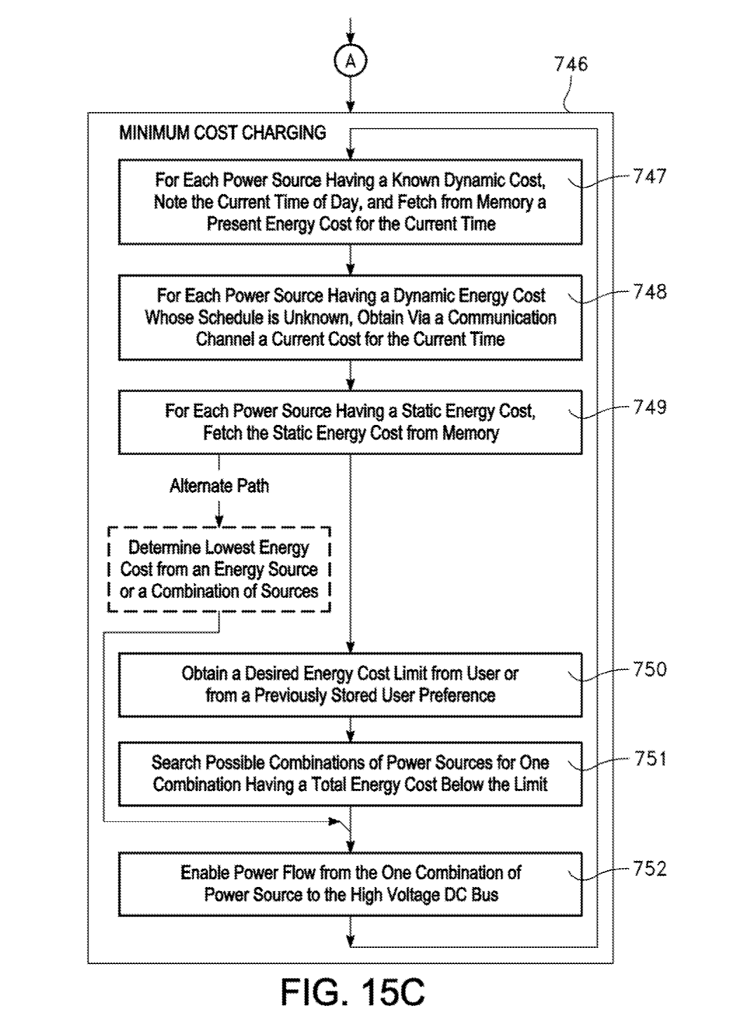

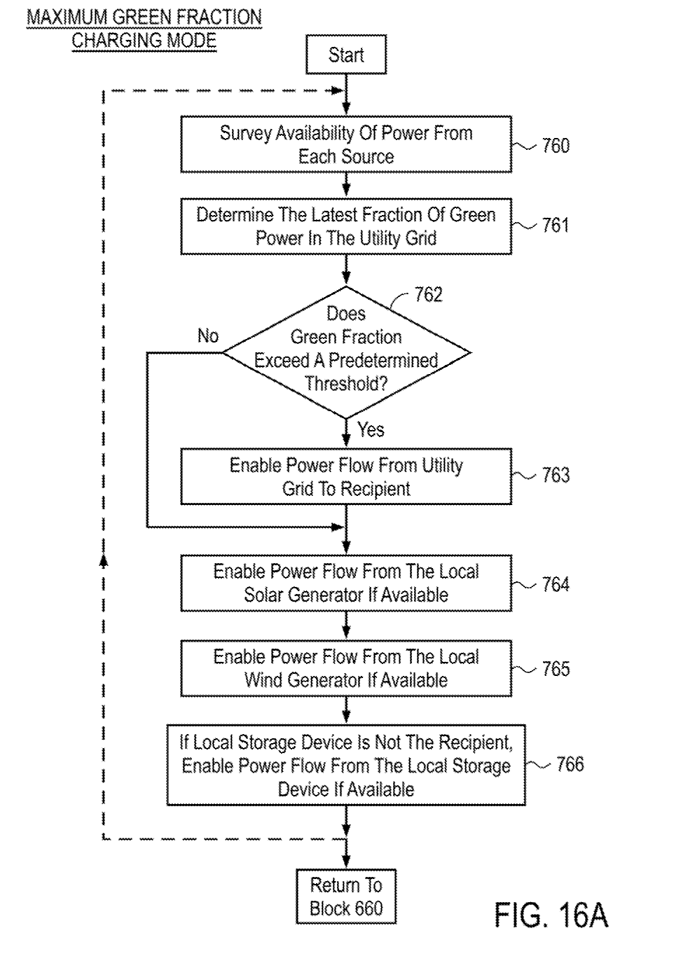

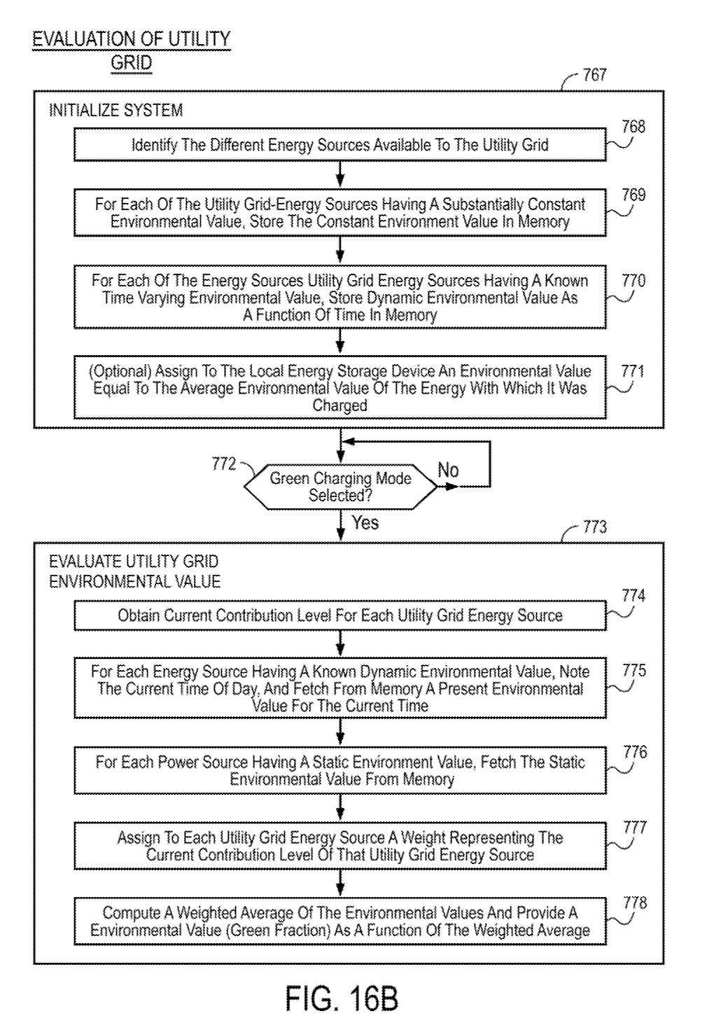

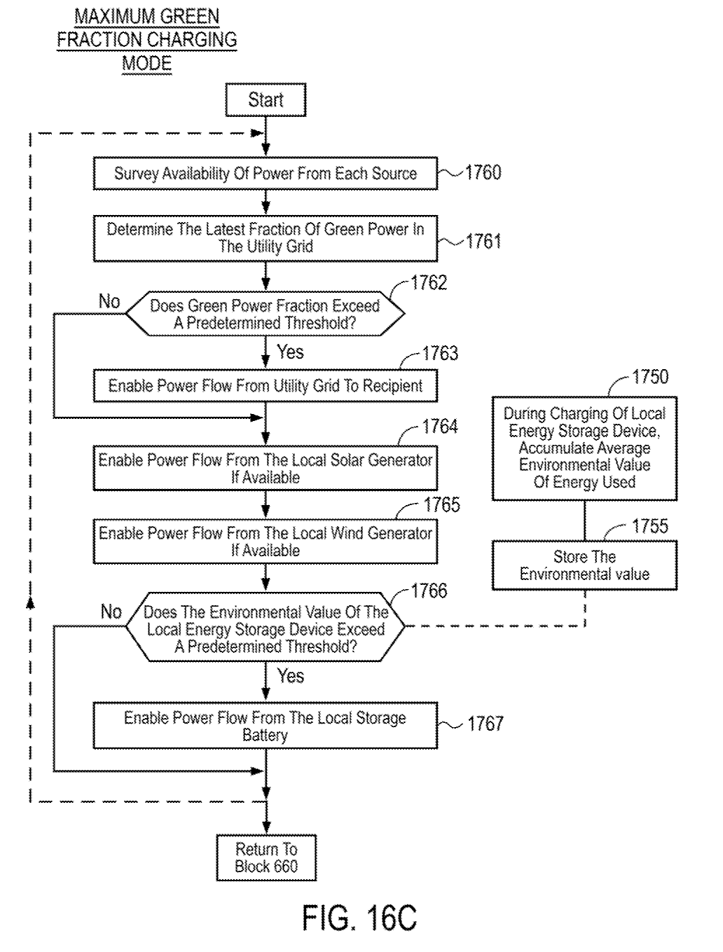

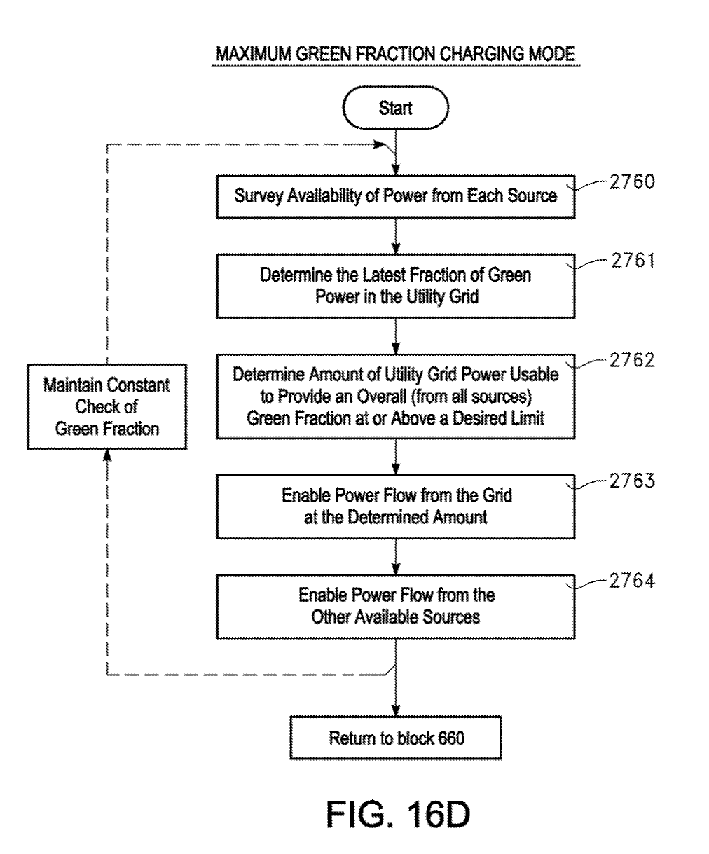

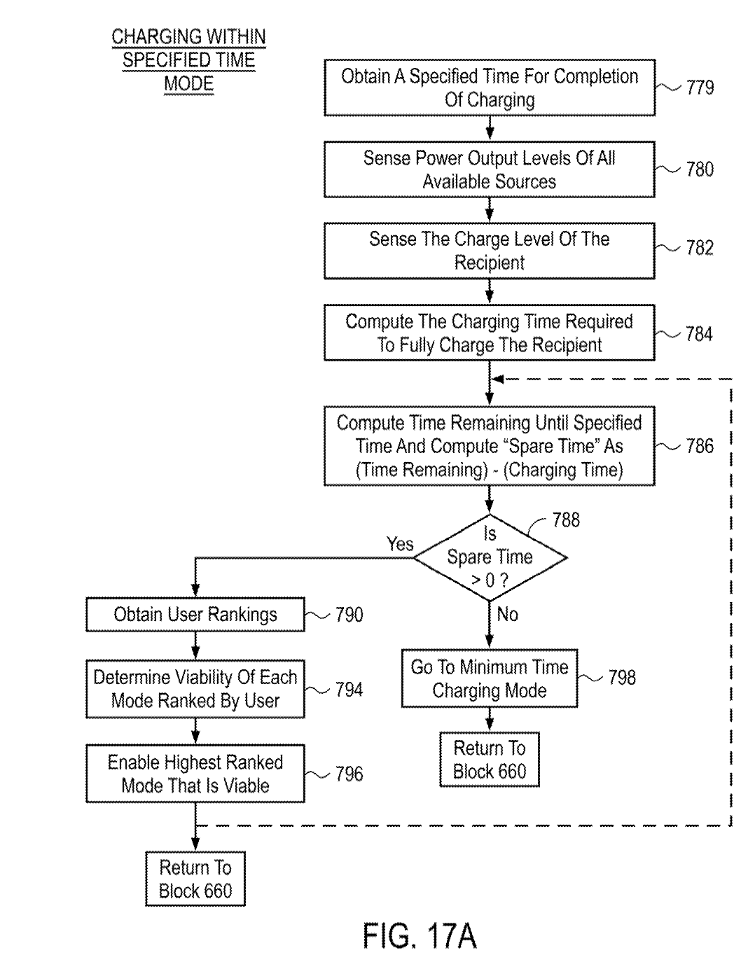

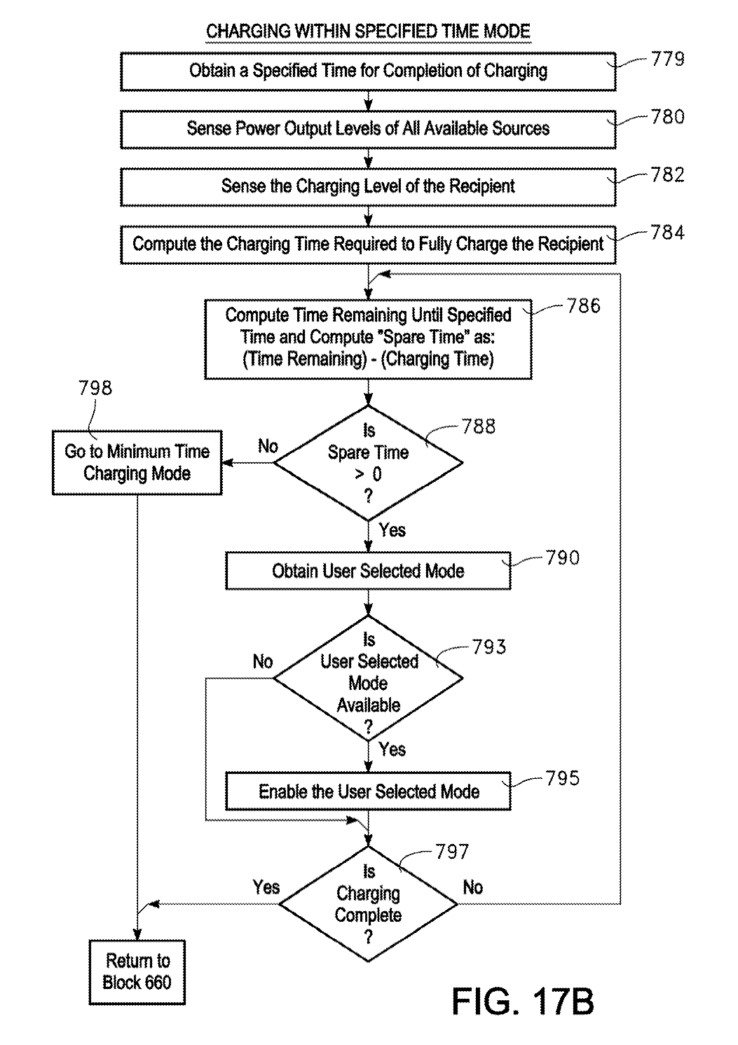

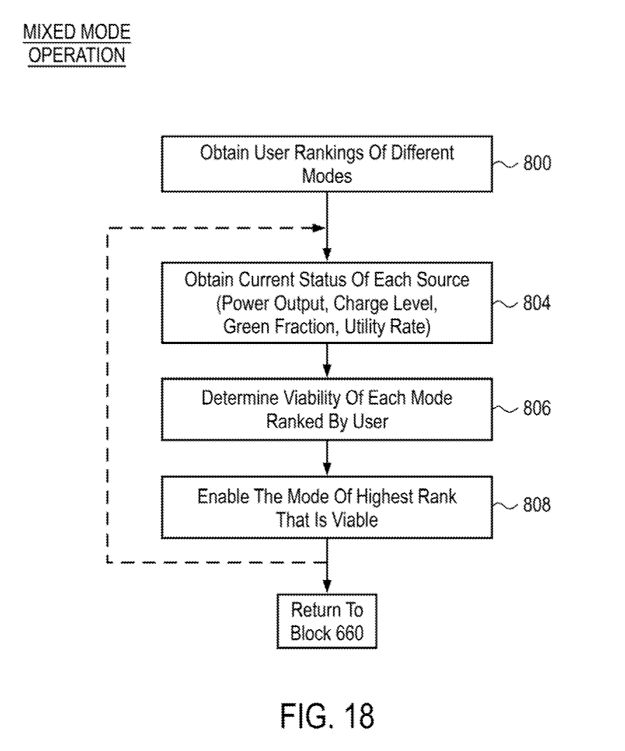

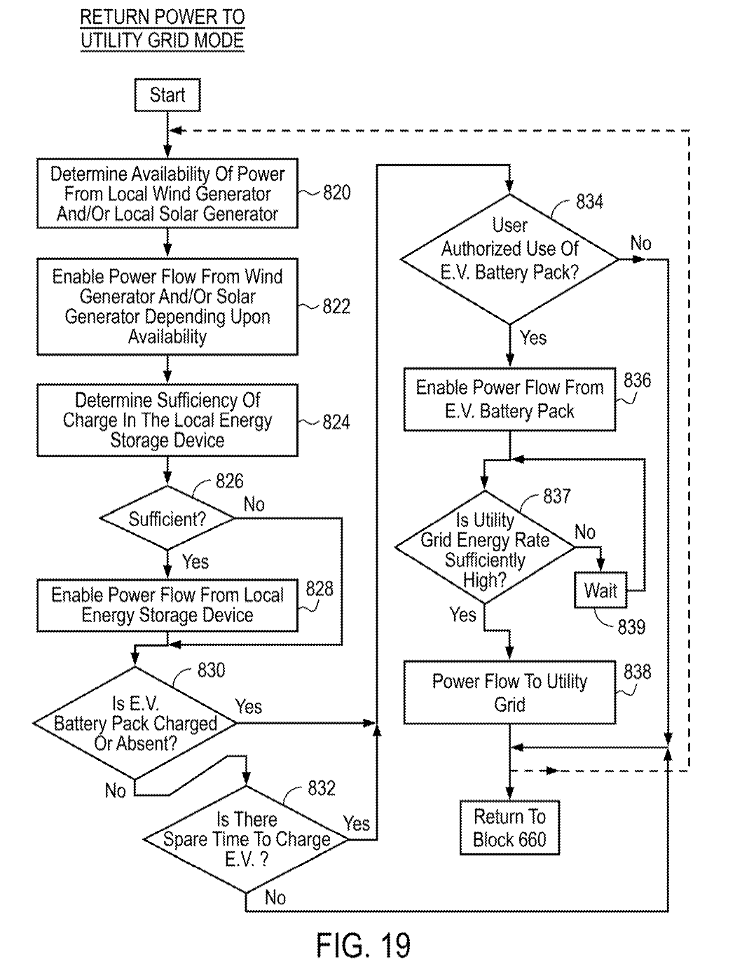

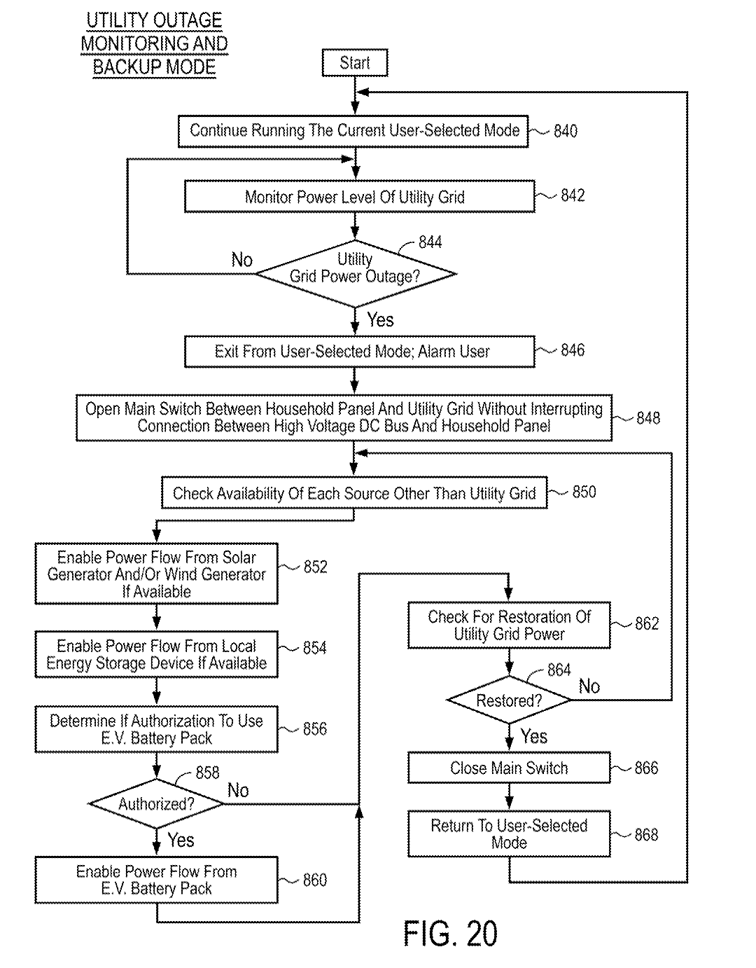

If the user-selected mode detected in the operation of block 660 is the minimum charging time mode (YES branch of block 664), then the energy management system performs the minimum charging time mode (block 666), an embodiment of which is depicted in FIG. 14, discussed later herein. If the user-selected mode is the minimum cost charging mode (YES branch of block 668), then the energy management system 210 performs the minimum cost charging mode (block 670), an embodiment of which is depicted in FIG. 15A, discussed later herein. If the user-selected mode is the green charging mode (YES branch of block 672), then the energy management system 210 operates in the green charging mode (block 674) in which the fraction of power from green sources is maximized. An embodiment of the green charging mode is depicted in FIG. 16A, discussed later herein. If the user-selected mode is the mode of charging within a user-specified time (YES branch of block 676), then the energy management system operates in the mode of charging within a specified time (block 678), an embodiment of which is depicted in FIG. 17A. If the user-selected mode is a mixed mode operation (YES branch of block 680), then the energy management system operates in the mixed mode operation (block 682), an embodiment of which is depicted in FIG. 18. If the user-selected mode is the return power to grid mode (YES branch of block 684), then the energy management system operates in the return power to grid mode (block 686), an embodiment of which is depicted in FIG. 19, discussed below. If the user-selected mode is the utility outage back-up mode (YES branch of block 688), then the energy management system 210 performs the utility outage back-up mode (block 690), an embodiment of which is depicted in FIG. 20. In this mode, the software instructions governing this mode are executed in the background. This allows any other mode selected by the user to be performed and dominate the user interface 350. As soon as a utility power outage occurs, the utility outage backup mode takes over, terminating the previous mode, as will be described below with reference to FIG. 20.

The determination of the power recipient of block 662 of FIGS. 12A and 12B is depicted in FIG. 13. A first step in FIG. 13 is to sense the user's selection of a power recipient (block 700 of FIG. 13), which may use the recipient selection window 394 in the display 390 of FIG. 7 to provide user interaction. Alternatively, the selection of the power recipient may be made automatically by reference to user preference date previously entered into the system. If the power recipient selected by the user is the electric vehicle battery pack 110 (YES branch of block 702), then power from the high voltage D.C. bus 300 is routed to the electric vehicle battery pack 110 in the manner depicted in FIG. 5B, for example (block 704). If the power recipient selected by the user is the local energy storage device 230 (YES branch of block 706), then power from the high voltage D.C. bus 300 is routed to the local energy storage device in the manner depicted in FIG. 5A, for example (block 708). If the user has selected both the battery pack 110 and the local energy storage device 230 to be a combined recipient (YES branch of block 710), then power from the high voltage D.C. bus is routed to both the battery pack 110 and the local energy storage device 230 in the manner of FIG. 5D, for example (block 712). The local energy storage device 230 may be implemented as a rechargeable battery pack. In accordance with various embodiments, the particular power distribution between the electric vehicle battery pack 110 and the battery pack constituting local energy storage device 230 can vary depending upon a variety of factors, including the level of charge of each pack, the temperature of each pack, the time of day, the scheduled use of each pack, the defined user distribution for each pack, and/or a combination thereof. If the user has made no selection (NO branch of block 710) or if the user designates the automatic selection mode, then the power recipient is selected in an automatic mode (block 714). The first step of the automatic mode 714 is to determine whether the battery pack 110 is fully charged (block 716). If so (YES branch of block 716), then a determination is made of whether the local energy storage device is fully charged (block 718). If this latter determination is confirmed (YES branch of block 718), then, in accordance with one embodiment, the energy management system performs the return power to grid mode (block 720), in which current from the high voltage D.C. is routed to the utility grid 220, in the manner of FIG. 5E, for example. In the determination of block 716, if the battery pack 110 is not fully charged (NO branch of block 716), then power from the high voltage bus 300 is routed to the battery pack 110 in the manner of FIG. 5E, for example (block 724). In the determination of block 718, if the local energy storage device 230 is not fully charged (NO branch of block 718), then power from the high voltage bus 300 is routed to the local energy storage device 230, in the manner depicted in FIG. 5A, for example (block 722).

The mode of charging in minimum time of block 666 of FIGS. 12A and 12B is illustrated in FIG. 14. In FIG. 14, a first step is for the master controller 310 to survey each of the energy sources and determine the output power level of each in order to assess its availability (block 730 of FIG. 14). This determination depends upon both output power levels and the selection of the power recipient. Power is then routed from each available energy source via the high voltage D.C. bus 300 to the power recipient (block 732 of FIG. 14). With the minimum-time charging mode the master controller will utilize the available energy sources to supply the maximum amount of power to the power recipient in order to minimize the time to charge the power recipient. In embodiments, the master controller may have a pre-defined (user or factory) preference as to the order of use of the available energy sources and the extent of that use (e.g. which to use first, and then next, etc. and the amount to use from each source) to reach the maximum amount of power. For example, the master controller may give priority to the solar generator over the utility as the solar power has no direct cost associated with it. Nevertheless, in this mode the master controller would fill in the power needs with the utility or any other power sources having a cost of power, in order to meet the power requirements of minimum-time charging of the power recipient.

The minimum cost charging mode of block 670 of FIGS. 12A and 12B is depicted in FIG. 15A in accordance with one embodiment. In the method of FIG. 15A, the master controller 310 surveys the power outputs of the energy sources to determine the availability of each (block 734 of FIG. 15A). If the solar generator 250 is available, its output power is routed to the high voltage D.C. bus 300 (block 735). If the wind generator 240 is available, then its output power is routed to the high voltage D.C. bus 300 (block 736). If the local energy storage device 230 is not the power recipient, and if it is available, then power from the local energy storage device 230 is routed to the high voltage D.C. bus 300 (block 737). The current energy rate or cost (e.g., dollars per kilowatt hour) of power from the utility grid 220 is obtained via the information channel 380 depicted in FIG. 6 (block 738). A determination is made of whether the utility grid energy rate is below peak demand levels (block 739). If so (YES branch of block 739), power flow from the utility grid 220 to the high voltage D.C. bus is enabled (block 740). Otherwise (NO branch of block 739), power from the utility grid is not used. The method of FIG. 15A at this juncture may cycle back to the step of block 734 or back to block 660. In embodiments, the rate or cost of power from the utility grid is obtained from any of a source including the internet, a wireless connection, predefined and stored value or values, and/or a user inputted value.

In another embodiment of the minimum cost charging mode, each of the energy sources available to the household (the utility grid 220, the local energy storage device 230, the wind generator 240 and the solar generator 250) has an associated energy rate or energy cost (in dollars per kilowatt hour) for the power that it provides, and the master controller 310 utilizes these costs to select what energy sources to use to provide power to the power recipient (via the high voltage D.C. bus 300) in such a manner as to keep the total energy cost below a desired limit or to minimize it. The particular energy cost for each energy source may be either set at a given value (static) over time, or may be dynamic over time. The static energy cost is determined by a pre-defined value. For example, the household wind energy source (the wind generator 240) might have a fixed energy cost given the known average maintenance cost of the wind turbine over time. The local energy storage 230 (e.g., a rechargable home battery) can have associated with it a cycle cost, which represents the wear and tear on the battery over time, e.g. the cost of the degrading of the battery over its life, and/or due to charging or operating the battery in a sub-optimal manner (e.g. when too hot, over charging, and the like). In another example, the solar panels of the solar generator 250, not having a significant maintenance cost over time, may be assigned a zero energy cost. The dynamic energy cost can either be obtained from a pre-defined schedule providing energy cost for a given time (e.g., set in a look-up table storing cost as function of the time of day for use by the master controller 310) or can be received over time from a reporting source. In one example of such a reporting of the energy cost, the current rate (e.g., dollars per kilowatt hour) of the utility grid 220 is obtained via the information channel 380 depicted in FIG. 6. In such embodiments the system determines and stores the energy cost or value of the energy with which the local energy storage device has been charged (an average over time), which can be used as the local energy storage device energy cost for use in the master controller's 310 selection of energy sources to supply power to the power recipient (e.g. either the battery pack 110 and/or the grid) to minimize costs.

This latter embodiment of the minimum cost charging mode is illustrated in FIGS. 15B and 15C. Referring to FIGS. 15B and 15C, prior to performing the minimum cost charging mode, a system initialization (block 741) is performed to define the energy cost of each power source (e.g., the utility grid 220, the local energy storage device 230, the wind generator 240 and the solar generator 250). For each power source having a substantially constant energy cost over time, the constant energy cost is stored e.g., in a memory accessible by the master controller 310 (block 742). For each power source having a known time-varying (dynamic) energy cost, energy cost as a function of time is stored in memory, so that a particular energy cost may be fetched from memory for any value of time within a predetermined time range (block 743). An optional operation is to assign an energy cost to the local energy storage device 230 based upon the cost of the energy that was used to charge the energy storage device (block 744). This may be achieved by monitoring the utility rate charged by the operator of the utility grid 220 during the time (or times) that the local energy storage device 230 is charged from the utility grid 220, and accumulating the energy costs thus monitored to provide an accurate accounting of the cost of the energy stored in the local energy storage device 230. (Such monitoring- and accumulating is performed prior to the initialization operation of block 741.)

Upon completion of the initialization of block 741, the system waits for the minimum cost charging mode to be selected (block 745) and does not enter the minimum cost charging mode if it has not been selected (NO branch of block 745). Upon the minimum cost charging mode being selected (YES branch of block 745), the minimum cost charging mode of block 746 is performed. The minimum cost charging mode of block 746 is in accordance with an embodiment different from the minimum cost charging mode of FIG. 15A. In block 746, for each power source having a known dynamic energy cost, the current time is noted and used to fetch the appropriate energy cost from memory (block 747). For each power source having a dynamic energy cost whose schedule is not known to the system, the system (e.g., the master controller 310) obtains the current energy cost through a communication channel (block 748). The system may periodically update a schedule through a communication channel to keep the schedule up to date. For example, in the case of the utility grid 220, this information may be obtained through the communication channel 380. For each energy source having a static energy value, the static energy value is obtained from memory (block 749). Static energy values can be entered into the system and updated through any of a variety of means including, but not limited to, user entry, software updates, data updates, and/or via a communication channel. A desired energy cost limit may be obtained either from previously entered user preference data or a new updated limit may be entered by the user via the user interface (block 750) or other means via the communication channel, such as a remote logon. In some embodiments a desired cost limit may not be utilized, provided and/or available, as shown in the alternate path depicted in FIG. 15B. In such cases the system will default to using the power source, or combination of power sources, which provides the lowest cost.

The master controller 310 determines what combination of power sources would provide power at an energy cost not exceeding the limit or that is the lowest cost. It may do this, for example, by searching all possible combinations of the power sources (block 751). For each combination, the effective energy cost is computed as a weighted average of the energy costs of the power sources of the particular combination, weighted in accordance with the power contribution of each source. The one combination providing the most acceptable results (e.g., the lowest cost or a cost below the desired energy cost limit) is chosen, and power flow from the power sources corresponding to the one combination to the high voltage DC bus 300 is enabled (block 752).

The mode of charging using a maximum fraction of power from green sources (green charging) performed in block 674 of FIGS. 12A and 12B, an embodiment of which is illustrated in FIG. 16A. Referring to FIG. 16A, the power outputs of the household energy sources (i.e., the utility grid 220, the local energy storage device 230, the wind generator 240 and the solar generator 250) are sensed to determine the availability of each source (block 760). For power from the utility grid 220, the latest fraction of the total power contributed to the utility grid 220 from green sources (which may be referred to as the green fraction or environmental value) is obtained through the utility information channel 380 (block 761). In embodiments, the green fraction is obtained from any of a source including the internet, wireless connection, predefined and stored value or values, and/or a user inputted value. The green fraction represents an environmental value of the energy in accordance with the proportion of non-polluting or renewable energy sources that contributed to the energy. However, the environmental value may instead represent an environmental cost or measure of carbon footprint or pollution. In the following examples, the environmental value corresponds to a green fraction, but embodiments are not limited thereto. A determination is made of whether the latest green fraction is above a predetermined threshold value (block 762). If so (YES branch of block 762), power flow from the utility grid 220 to the high voltage D.C. bus 300 is enabled (block 763). Otherwise (NO branch of block 762), no power flows from the utility grid 220 to the high voltage D.C. bus 300. Power flow is enabled from the solar generator 250 if available (block 764). Power flow from the wind generator 240 is enabled if available (block 765). If the local energy storage device 230 is not the power recipient, and if power from the local energy storage device 230 is available, then power flow from the local energy storage device 230 to the high voltage bus 300 is enabled (block 766). Thereafter, the energy management system 210 may return to the step of block 660 of FIGS. 12A and 12B.

Determination of the utility grid power green fraction of block 762 of FIG. 16A may be carried out locally by the system using an environmental evaluation method based upon the environmental value of each one of the individual power sources available to the utility grid 220 (i.e., the on-site power sources 371 and 372, and the off-site renewable energy sources 373, 374, 375 and 376). In various embodiments of the evaluation method, each of the power sources 371-376 may be assigned a static or dynamic environmental value (stored in a lookup table) related to or determined from the nature of the power that they provide. For example, energy provided by the solar cell array electrical source 376 of FIG. 6 may be given a preferred value compared to energy provided from the hydroelectric source 374 or the wind farm electric generator source 375 (determined by a presumption that solar has less environmental impact than the other sources). The foregoing is provided only as an example, and such determinations may be made in other ways. In this manner, the green fraction or environmental value of the utility grid power may be accurately determined, so that the predetermined threshold of block 764 might be reached if a greater percentage of the utility grid energy is generated by sources with greater environmental values than otherwise. Of course such determination is dependent on the accuracy and detail of the information provided by the utility grid 220. A method in accordance with the foregoing for evaluating the environmental value or green fraction of the utility grid power is described below with reference to FIG. 16B.

Referring again to FIG. 16A, performance of the operation of block 766 of FIG. 16A, in which power flow from the local energy storage device 230 is enabled, may be contingent upon the green fraction, or environmental value, of the energy stored in the local energy storage device. The energy stored in the local energy storage device 230 can be assigned an environmental value corresponding to the environmental value of the energy with which it was charged (an average over time), which can be used as its environmental value for selection by the master controller 310 of power sources to supply power to the vehicle battery pack 110. Thus, the master controller may make a determination of whether to use power from the local energy storage device 230 based upon the environmental value of the power consumed in charging the local energy storage device 230. How this latter determination may be carried out is described below with reference to FIG. 16C.

Referring to FIG. 16B, a method of evaluating the green fraction of the utility grid power (used in the determination performed in block 761 of FIG. 16A) is now described. Evaluation is based upon an environmental value associated with each power source. The environmental value may be equivalent to the green fraction (the fraction of power attributable to non-polluting or renewable energy sources), so as to increase in magnitude with the environmentally desirable characteristics. Alternatively, the environmental value may represent a cost, analogous to a carbon emission value, and may decrease in magnitude with environmentally desirable characteristics. In FIG. 16B, a system initialization, depicted in block 767, is performed prior to the evaluation of the utility grid energy environmental value. In the system initialization of block 767, a communication channel such as the communication channel 380 of FIG. 6 may be used to determine the various utility grid energy sources (e.g., the utility grid sources 371-376) that are currently on line to contribute power, and their relative individual contributions to the total grid power (block 768). For each utility grid energy source having a substantially constant environmental value, that value is stored in memory (block 769). For each utility grid energy source having a dynamically (time varying) environmental value, the environmental value is stored in memory as a function of time for a predetermined time range (block 770). An optional operation is to assign an environmental value to the local energy storage device 230 based upon the environmental value of the energy that was used to charge the energy storage device (block 771). This requires a prior monitoring of the environmental value of the power taken from the utility grid 220 during the time (or times) that the local energy storage device 230 is charged from the utility grid 220, and accumulating the environmental values thus monitored to provide an accurate accounting of the environmental value of the energy stored in the local energy storage device 230.

Upon completion of the initialization of block 767, the system waits for selection of the maximum green fraction charging mode (block 772). If no such selection is made, the system waits (NO branch of block 772). Once the maximum green fraction charging mode is selected (YES branch of block 772), the system proceeds to determine the latest environmental value or green fraction of the utility grid power based upon the current time (block 773). The evaluation operation of block 773 begins by obtaining the current level of power contributed by each utility grid energy source (block 774). For each power source having a known dynamic environmental value, the current time is noted and used to fetch the present environmental value for the current time from memory (block 775). For each energy source having a static environmental value, the static environmental value is obtained from memory (block 776). The environmental value of each energy source is assigned a weight according to its power contribution relative to the other sources (block 777), and the environmental value of the utility grid power is computed as a weighted average of the environmental values of the individual sources (block 778). This is the value employed in the determination of the operation of block 761 of FIG. 16A. Other methods of computation may be performed to determine the utility grid power environmental value in accordance with the foregoing.

FIG. 16C illustrates a modification of the maximum green fraction charging mode of FIG. 16A, in which a decision is made of whether to draw energy from the local energy storage device 230 depending upon the environmental value or green fraction of the energy consumed in charging the local energy storage device 230. Referring to FIG. 16C, prior to the performance of the maximum green charging mode, charging of the local energy storage device 230 is monitored to determine the environmental value or green fraction of the energy stored in the local energy storage device 230 (block 1750). For example, during charging of the local energy storage device with utility grid power, the latest environmental value(s) computed in the operation of block 778 of FIG. 16B are averaged over time. An overall average is computed by folding into this average a maximum green fraction or environmental value for any energy contributed to the local energy storage device by the local renewable energy sources (the wind and solar generators 240, 250). The resulting environmental value is stored for later use during performance of the maximum green fraction charging mode in deciding whether to use the local energy storage device 230 (block 1755).

Continuing to refer to FIG. 16C, when the maximum green fraction charging mode is selected, the power outputs of the household energy sources (i.e., the utility grid 220, the local energy storage device 230, the wind generator 240 and the solar generator 250) are sensed to determine the availability of each source (block 1760). For power from the utility grid 220, the latest fraction of the total power contributed to the utility grid 220 from green sources (which may be referred to as the green fraction) is obtained through the utility information channel 380 (block 1761). A determination is made of whether the latest green fraction of the utility grid power is above a predetermined threshold value (block 1762). If so (YES branch of block 1762), power flow from the utility grid 220 to the high voltage D.C. bus 300 is enabled (block 1763). Otherwise (NO branch of block 1762), no power flows from the utility grid 220 to the high voltage D.C. bus 300. Power flow is enabled from the solar generator 250 if available (block 1764). Power flow from the wind generator 240 is enabled if available (block 1765). A determination is made of whether to draw power from the local energy storage device 230 (block 1766). The determination of block 1766 is based upon whether the environmental value of the energy stored in the local energy storage device 230 is above a predetermined threshold. The environmental value of the local energy storage device 230 is obtained as the value previously stored in the step of block 1755. The determination of block 1766 may involve additional criteria, e.g., determining whether the local energy storage device is available and that it is not the power recipient. If the local energy storage device environmental value exceeds the predetermined threshold (YES branch of block 1766), and if the additional criteria are met, then power flow from the local energy storage device 230 to the high voltage bus 300 is enabled (block 1767). Otherwise (NO branch of block 1766), power flow from the local energy storage device 230 is not enabled. Thereafter, the energy management system 210 may return to the step of block 660 of FIGS. 12A and 12B.

A variation of the embodiment of FIG. 16C is illustrated in FIG. 16D. Referring now to FIG. 16D, when the maximum green fraction charging mode is selected, the power outputs of the household energy sources (i.e., the utility grid 220, the local energy storage device 230, the wind generator 240 and the solar generator 250) are sensed to determine the availability of each source (block 2760). For power from the utility grid 220, the latest fraction of the total power contributed to the utility grid 220 from green sources (which may be referred to as the green fraction) is obtained through the utility information channel 380 (block 2761). Then, a determination is made of the amount of utility grid power usable to provide an overall green fraction (from all available sources) at or above a desired green fraction limit or threshold (block 2762). Power flow is then enabled from the utility grid at the rate or amount determined in block 2762 (block 2763). Power flow is enabled from the other available sources (block 2764). The process may then loop back (as indicated in dashed line) to block 2760 for a constant check of green power fraction. Otherwise, the process returns to block 660.

The mode of charging within a specified time that is performed in block 678 of FIGS. 12A and 12B is illustrated in FIG. 17A in accordance with one embodiment. Referring to FIG. 17A, a specified time by which charging (e.g., of the electric vehicle battery pack 110) must be complete, is obtained (block 779). This may be done by referring to preferences that have been previously stored in memory, e.g., by the user. Alternatively, this may be done at the last moment by prompting the user to enter the specified time via the user interface. The output power levels of all the energy sources available to the household (i.e., the utility grid 220, the local energy storage device 230, the wind generator 240 and the solar generator 250) are sensed to determine the availability of each energy source and to determine the total power currently available to charge the power recipient (block 780). The charge level or amount of electrical charge currently held in the power recipient is sensed (block 782). From the information gathered in performing blocks 780 and 782, the charging time required to fully charge the power recipient is computed (block 784). The time remaining until expiration of the specified time is computed, and a spare time is then computed as the difference between the time remaining and the required charging time (block 786). If the spare time is not greater than a predetermined threshold, e.g., zero or, preferably, a safety buffer such as one hour (NO branch of block 788), then the system cannot or should not charge in an alternative mode, and the energy management system returns to block 660 of FIGS. 12A and 12B. If the spare time is greater than the threshold (YES branch of block 788), then it is possible to charge in another (alternative) mode for a temporary period of time. The user's preference for the alternative mode (i.e., the user selected mode) is obtained either from preset preference data previously entered during initialization (or as a recent input from the user), possibly in the form of a list with each mode ranked by preference (block 790). For example, the charging could be carried out in the minimum cost charging mode temporarily. The availability of the user selected mode is determined (block 793). If the user-selected mode is available (YES branch of block 793), then the user selected mode is enabled (block 795). If the user selected mode is not available (NO branch of block 793), the user selected mode is not enabled. After enabling the user selected mode (block 795) or after determining the user selected mode is not available (NO branch of block 793), a determination is made of whether charging is complete (block 797). If charging is not complete (NO branch of block 797), the process returns to block 786. Otherwise, if charging is complete (YES branch of block 797), the energy management system may then return to block 660 of FIGS. 12A and 12B.

If the determination made in block 788 finds that there is insufficient spare time, e.g., less than a safety buffer such as one hour (NO branch of block 788), then the energy management system 210 performs the mode of charging in minimum time (block 798). Thereafter, the energy management system may return to block 660 of FIGS. 12A and 12B.

FIG. 17B depicts a modification of the method having the elements of FIG. 17A, except as follows: In FIG. 17B, the user preference(s) obtained in block 790 may be simply the designation of a single preferred mode. Moreover, the next step is to determine the viability of the preferred mode only (block 793). Thereafter, the preferred mode is enabled whenever it is viable, and otherwise charging is postponed (block 795). Such postponement or waiting is acceptable because there is spare time remaining before the system would need to transition to the minimum time charging mode to achieve a full charge of the electric vehicle battery pack by the specified time. An example is that the user may be going away for the weekend, leaving the electric vehicle behind, and wants to have the vehicle battery pack fully charged by Monday morning. In such a case, during the weekend, the charging would be carried out cost-free at least part way via solar or wind charging by the wind generator 240 or the solar generator 250, and then Monday morning at an early hour (e.g., 1:00 am), charging from the utility grid 220 would be initiated to finish the charging on time.

A complete description of FIG. 17B is now given. A specified time by which charging (e.g., of the electric vehicle battery pack 110) must be complete, is obtained (block 779). This may be done by referring to preferences that have been previously stored in memory, e.g., by the user. Alternatively, this may be done at the last moment by prompting the user to enter the specified time via the user interface. The output power levels of all the energy sources available to the household (i.e., the utility grid 220, the local energy storage device 230, the wind generator 240 and the solar generator 245) are sensed to determine the availability of each energy source and to determine the total power currently available to charge the power recipient (block 780). The charge level or amount of electrical charge currently held in the power recipient is sensed (block 782). From the information gathered in performing blocks 780 and 782, the charging time required to fully charge the power recipient is computed (block 784). The time remaining until expiration of the specified time is computed, and a spare time is then computed as the difference between the time remaining and the required charging time (block 786). If the spare time is greater than a predetermined threshold, e.g., zero or, preferably, a safety buffer such as one hour (YES branch of block 788), then it is possible to charge in another (alternative) mode for a temporary period of time. The user's preference for the alternative mode (i.e., a user selected mode) is obtained (block 790). For example, the charging could be carried out in the minimum cost charging mode temporarily. The availability of the preferred or user selected mode is determined (block 793). If the user-selected mode is available (YES branch of block 793), the user selected mode is enabled (block 795), and a determination is made of whether the charging is complete (block 797). If charging is complete (YES branch of block 797), the process returns to block 660. Otherwise (NO branch of block 797) the process returns to block 786. Considering again the determination of block 793, if the user selected mode is not available (NO branch of block 793), then the process skips to block 797 for a determination of whether charging is complete. If charging is complete (YES branch of block 797), the process returns to block 660. Otherwise (NO branch of block 797) the process returns to block 786.

The mixed mode operation performed in block 682 of FIGS. 12A and 12B is illustrated in FIG. 18. Referring to FIG. 18, the user's rankings of the different modes in order of preference is obtained (block 800). In one embodiment, the rankings have been previously entered as preset user preference data prior to operation. In another embodiment, the rankings may be entered contemporaneously by the user via the user interface 350 in response to a system prompt, for example. Once the user's rankings are obtained, the status of each energy source ranked by the user is determined (block 804). The status includes information affecting the viability of the modes ranked by the user, and may include such characteristics as output power level, charge level (for a rechargeable energy source), green power fraction (for the utility grid), utility rate or dollars per kilowatt hour (for the utility grid), the environmental value or other relevant factors. From the foregoing status information, the viability of each mode ranked by the user is determined (block 806). The mode of highest rank that is currently viable is determined, and that mode is performed (block 808). The energy management system 210 may then return to block 804 or to block 660 of FIGS. 12A and 12B.

The mode in which power is returned to the utility grid that is performed in block 686 of FIGS. 12A and 12B is illustrated in FIG. 19. The availability of each of the local renewable energy sources, including the wind generator 240 and the solar generator 250, is determined by sensing their respective output power levels (block 820). Power flow to the high voltage D.C. bus from each of the local renewable energy sources that is available is enabled (block 822). The amount of charge in the local energy storage device 230 is determined (block 824). If the charge is sufficient or above a predetermined threshold (YES branch of block 826), then power flow to the high voltage D.C. bus 300 from the local energy storage device 230 is enabled (block 828). Otherwise (NO branch of block 826), the charge is insufficient, and the local energy storage device is not used. A determination is made of whether the electric vehicle battery pack 110 is fully charged or absent (block 830). If not (NO branch of block 830), a determination is made whether there is spare time remaining before charging in the minimum time mode would have to begin to fully charge the battery pack by a specified time defined in previously entered user preference data (block 832). This determination of the spare time may be carried out in accordance with the operation of blocks 780, 782, 784 and 786 of FIG. 17A as described above, for example. Continuing with the description of FIG. 19, if it determined that the electric vehicle battery pack is fully charged or absent (YES branch of block 830) or if it is determined that there is spare time (YES branch of block 832)−e.g., beyond a preset minimal value or buffer, then a determination is made whether previously entered user preference data authorizes drawing power from the electric vehicle battery pack 110 (block 834). If so (YES branch of block 834), then power flow from the battery pack 110 to the high voltage D.C. bus 300 is enabled (block 836). Optionally, prior to enabling power flow from the high voltage D.C. bus 300 to the utility grid 220, a determination is made of whether the present utility grid energy rate is sufficiently high to warrant returning power to the utility grid 220 (block 837). The determination of block 837 enables the system to maximize income on power returned to the utility grid 220, in a manner discussed below. The determination of the sufficiency of the energy rate in block 837 may be made in accordance with a predetermined energy rate criteria. For example, the criteria may be that the energy rate lie within a range of energy rates charge by the operator of the utility grid during hours of peak power demand on the energy grid. Such information may be obtained via the communication channel 380 of FIG. 6 or may be predicted based upon prior energy rate trends observed on the utility grid. As another example, the criteria may be that the energy rate be above a selected threshold. If the energy rate is sufficient (YES branch of block 837), then the system enables power flow from the high voltage D.C. bus 300 to the utility grid 220 block 838), the utility grid 220 having been designated previously as the power recipient in the step of block 662 of FIGS. 12A and 12B. Otherwise (NO branch of block 837), power flow to the utility grid 220 is not enabled, and the system either waits for the utility grid energy rate to increase to a sufficient level (block 839), or returns to block 820 or to block 660 of FIGS. 12A and 12B.

Returning to the discussion of blocks 832 and 834, if it is determined that there is no spare time before minimum time charging must begin (NO branch of block 832) or that drawing power from the battery pack is not authorized (NO branch of block 834), power flow to the utility grid is not enabled (so that the system can concentrate on charging the electric vehicle battery pack). The energy management system 210 may then return to block 820 (as indicated in dashed line) or to block 660 of FIGS. 12A and 12B.

Returning the system to block 820 is advantageous, because, in those instances in which power is drawn from the electric vehicle battery pack 110, it prevents drawing down the electric vehicle battery pack charge below a level at which insufficient spare time remains in which to fully charge it in the maximum rate mode by a specified time. Whenever the system is drawing power from the electric vehicle battery pack 110, it recycles back to block 820 to ensure that the verification of block 832 is performed once each cycle to ensure sufficient spare time still remains. This cycle is rapidly repeated during the time power is drawn from the electric vehicle battery pack 110, to guard against depleting it to the point that the remaining spare time becomes insufficient.

It should be noted that inclusion of the optional determination of block 837 in the mode of FIG. 19 enables an embodiment for maximizing income from providing power to the utility grid 220, by intelligently limiting the time windows during which the enabling of power flow to the utility grid 220 in block 838 is performed. The time windows are defined using the determination of block 837 so as to maximize income from the utility grid operator. This maximizing income embodiment may exploit the tendency of the utility grid 220 to credit power returned to the grid at an energy rate (dollars per kilowatt hour) equal to the rate at which users are charged for taking power from the utility grid 220. In this maximizing income embodiment, power would be delivered to the utility grid based upon either reaching a certain value of the current reported energy rate and/or upon a predicted maximum value based on either pre-define values and/or an analysis of the history of reported maximum energy rates over time. To maximize such income, the local energy storage device 230, and/or optionally the vehicle battery pack 110, is/are charged by operating the system in the minimum cost charging mode as set forth above. Also, to maximize the income from providing power to the grid, the transfer of power to the grid is done as quickly as possible at a sufficiently high reported, energy rate and/or at or about the predicted maximum energy rate.

The utility outage monitoring and backup mode performed in block 690 of FIGS. 12A and 12B is illustrated in FIG. 20. The utility outage monitoring and backup mode can be implemented in a software or application program that runs in the background while permitting a software or application of another mode to be performed and control the energy management system 210. Thus, in FIG. 20, the utility outage monitoring and backup mode runs passively while monitoring the utility grid 220 for a power outage, and while allowing one of the other modes of FIGS. 13-19 to be performed. After a power outage occurs, the utility monitoring and backup mode is active and replaces whatever mode the system was operating in at the time of the outage.

Referring to FIG. 20, the current user-selected mode, i.e., one of the modes of FIGS. 13-19, continues to operate (block 840). In the meantime, the master controller 310 monitors the power level of the utility grid 220 (block 842). In block 844, determination that a utility grid power outage has occurred may be made, for example, whenever the sensed power or voltage level of the utility grid 220 falls below a predetermined threshold. If a power outage occurs (YES branch of block 844), then the system exits the current user-selected mode and causes the user interface 350 to notify the user (block 846). Then, as depicted in FIG. 5C, the master controller 310 causes the main switch 224-1 to open and interrupt connection between the household electric panel 224 and the utility grid 220 (block 848). This step leaves the household utility panel 224 connected to the high voltage D.C. bus 300. The master controller 310 verifies availability of each of the energy sources except the utility grid 220, namely the local energy storage device 230, the wind generator 240, the solar generator 250 and the battery pack 110 (block 850). Power flow is enabled to the high voltage D.C. bus 300 from the wind generator 240, if available, and from the solar generator 250, if available (block 852). Power flow from the local energy storage device 230 to the high voltage D.C. bus 300 is enabled (block 854), if power from the local energy storage device 230 is available. The local energy storage device 230 may not be available because the user may have made a selection to refrain from using it during a utility outage, as the user may want to keep it for later charging of the electric vehicle battery pack 110. In the case of a utility outage, in one embodiment the last power draw should be from the local energy storage device 230, because the local renewable sources (the wind and solar generators) should be used first.

A determination is made whether the previously entered user preference data, or recent entries by the user, contain an authorization to withdraw power from the electric vehicle battery pack in case of a power outage (block 856). If such a withdrawal is authorized (YES branch of block 858), then power flow from the battery pack 110 to the high voltage D.C. bus 300 is enabled (block 860).

In the backup mode described above, in the event of a loss of power from the utility grid 220, the household electric panel 224 is disconnected from the utility grid 220 and power flows from the high voltage D.C. bus 300 to the household electric panel 224. Referring to FIG. 3, the D.C. power from the high voltage D.C. bus is converted to A.C. power at the household voltage for delivery to the household electric panel 224. The household electric panel 224 may distribute the power throughout the house. During this time, the master processor 310 periodically checks the power level on the utility grid 220 (block 862). If power has been restored on the utility grid 220 (YES branch of block 864), then the electric panel 224 is reconnected to the utility grid 220 by closing the master switch 224-1 (block 866), operation in the previously selected mode is resumed (block 868) and operation of the backup mode returns to block 840. Otherwise, if utility grid power has not been restored (NO branch of block 864), the system continues to provide backup power to the household panel, while at the same time cycling back to the step of block 850 to re-verify the status of each source.

While the foregoing is directed to embodiments of the present invention, other and further embodiments of the invention may be devised without departing from the basic scope thereof, and the scope thereof is determined by the claims that follow.

What is claimed is:

1. A method of managing electrical energy, comprising:
coupling a direct current bus to plural energy sources and to a system port that is connectable to a charging port of an electric vehicle having a battery pack, said plural energy sources comprising a local energy storage device and a utility grid;
managing energy flow between said direct current bus and said plural energy sources by performing one mode of a set of modes, said set of modes comprising:
a minimum time charging mode,
a minimum cost charging mode,
a green charging mode that enhances the fraction of energy usage from utility grid renewable sources of the utility grid,
a specified completion time charging mode;
providing on a graphical user interface a first menu representing a user-selectable choice among said set of modes and performing the mode designated by the user on said menu; and
providing on a graphical user interface a second menu listing said plurality of electrical energy sources, and prompting the user to select one of said electrical energy sources listed on said menu as a recipient of power from the direct current bus, and configuring power flow among said plural energy sources and said direct current bus in accordance with a selection by the user of the recipient of power.

2. A method of managing electrical energy, comprising:
coupling a direct current bus to plural energy sources and to a system port that is connectable to a charging port of an electric vehicle having a battery pack, said plural energy sources comprising a local energy storage device and a utility grid;
managing energy flow between said direct current bus and said plural energy sources by performing one mode of a set of modes, said set of modes comprising:
a minimum time charging mode,
a minimum cost charging mode,
a green charging mode that enhances the fraction of energy usage from utility grid renewable sources of the utility grid,
a specified completion time charging mode;
wherein said plural energy sources further comprise a local renewable energy source, and wherein said one mode comprises a return power to utility grid mode, said return power to utility grid mode comprising:
enabling power flow to said direct current bus from said local renewable energy source;
determining whether a battery pack of an electric vehicle coupled to said system port requires charging;
if said battery pack requires charging:
sensing a specified time by which said battery pack is to be fully charged,
determining, from output power levels of said set of energy sources and from the amount of charge contained in said battery pack, an amount of time required to fully charge said battery pack in said minimum time charging mode,
determining from said amount of time and from said specified time a spare time currently remaining before charging of said battery pack in said minimum time charging mode is required to commence, and
if said spare time is sufficient in accordance with a predetermined spare time criteria, enabling power flow from said battery pack to said direct current bus.

3. The method of claim 2 further comprising:
if said spare time is not sufficient in accordance with the predetermined spare time criteria, not enabling power from said battery pack to said direct current bus.

4. The method of claim 2 further comprising:
if said battery pack does not require charging, enabling power flow from said battery pack to said direct current bus.

5. The method of claim 2 further comprising:
whenever power flows from said battery pack to said direct current bus, periodically determining a new value of said spare time, and if the new value of said spare time is not sufficient in accordance with a predetermined spare time criteria, disabling power flow from said battery pack to said direct current bus.

6. The method of claim 2 further comprising:
determining whether a current energy rate of said utility grid meets a predetermined criteria;
enabling power flow from said direct current bus to said utility grid if said current energy rate meets said predetermined criteria, and otherwise postponing power flow from said direct current bus to said utility grid until said energy rate meets said predetermined criteria.

7. The method of claim 6 wherein said predetermined criteria corresponds to a predetermined threshold energy rate.

8. The method of claim 6 wherein said predetermined criteria corresponds to an energy rate or a range of energy rates prevalent during periods of peak demand.

9. The method of claim 2 further comprising enabling power flow from said direct current bus to said utility grid during successive time windows, said successive time windows selected so as to enhance or maximize income from power provided from said direct current bus to said utility grid.

10. A method of managing electrical energy, comprising:
coupling a direct current bus to plural energy sources and to a system port that is connectable to a charging port of an electric vehicle having a battery pack, said plural energy sources comprising a local energy storage device and a utility grid;
managing energy flow between said direct current bus and said plural energy sources by performing one mode of a set of modes, said set of modes comprising:
a minimum time charging mode,
a minimum cost charging mode,
a green charging mode that enhances the fraction of energy usage from utility grid renewable sources of the utility grid,
a specified completion time charging mode;
wherein said one mode is said minimum cost charging mode, and said minimum cost charging mode comprises:
charging said battery pack by flowing energy to said direct current bus from said local energy storage device,
first determining whether said utility grid is imposing an energy rate below a predetermined rate, and flowing energy from said utility grid to said direct current bus if said energy rate is below the predetermined rate;
wherein said first determining comprises:
first obtaining individual energy costs of said plural energy sources and the power contribution proportions of said plural energy sources;
for individual combinations of said plural energy sources, computing a combined energy cost as an average of corresponding ones of said individual energy costs weighted by corresponding ones of said power contribution proportions;
second obtaining a user-defined energy cost limit;
searching for a combination of said plural energy sources having a combined energy cost that is below said user-defined energy cost limit;
prior to said first determining, charging said local energy storage device with energy from another or others of said plural energy sources;
during the charging of said local energy storage device, computing a first average of said individual energy costs weighted by the corresponding power contribution proportions of those of said plural energy sources providing energy to charge said local energy storage device, and storing said first average as a local energy storage device energy cost; and
wherein said first obtaining comprises defining said local energy storage device energy cost as the energy cost of said local energy storage device.
